(19) United States
(12) Patent Application Publication
(10) Pub. No.: US 2011/0148211 A1
(43) Pub. Date: Jun. 23, 2011

(54) SEMICONDUCTOR DEVICE

(75) Inventors: Fumiyoshi MATSUOKA, Kawasaki-Shi (JP); Ryo Fukuda, Yokohama-Shi (JP)

(73) Assignee: Kabushiki Kaisha Toshiba, Tokyo (JP)

(21) Appl. No.: 12/885,935

(22) Filed: Sep. 20, 2010

(30) Foreign Application Priority Data
Dec. 17, 2009 (JP) 2009-285977

(51) Int. Cl. H02J 4/00

(52) U.S. Cl. 307/80

(57) ABSTRACT

In a semiconductor device according to the embodiment, a core circuit is an IC. A peripheral circuit includes a driver supplied with voltages from an internal power source and an external power source and outputting data transferred from the core circuit, and a fetch portion transferring the digital data to the driver. A first power source supplies an internal voltage to the driver via a power source line. A second power source includes current driving strings each including a current driving element and a switching element connected in series between the external power source and the power source line. The second power source supplies a current to the power source line separately from the first power source line by driving the current driving strings. A power source controller controls the second power source to drive the current driving strings when a logic transition occurs among consecutive bits of the data.

### CROSS REFERENCE TO RELATED APPLICATIONS

This application is based upon and claims the benefit of priority from the prior Japanese Patent Application No. 2009-285977, filed on Dec. 17, 2009, the entire contents of which are incorporated herein by reference.

### FIELD

The embodiments of the present invention relate to a semiconductor device.

### BACKGROUND

A semiconductor device such as a semiconductor memory includes an OCD (Off Chip Driver) that outputs digital data to outside of a chip. For example, the OCD receives an internal power source voltage VINT and an external power source voltage VDDQ, amplifies data read from memory cells, and outputs the amplified data to outside of the chip.

The internal power source voltage VINT is not only supplied to the OCD but also used to drive a core circuit (such as a memory cell array) inside of the semiconductor device and a peripheral circuit of the core circuit. The internal power source voltage VINT is supplied to the OCD by, for example, a feedback power source circuit. The feedback power source circuit monitors the internal power source voltage VINT and changes an amount of supplying a current to internal circuits such as the OCD according to a variation in the internal power source voltage VINT. When current consumption of the internal circuits of the semiconductor device increases and the internal power source voltage VINT falls below a set value, the feedback power source circuit increases the amount of supplying the current to the internal circuits. When the internal power source voltage VINT exceeds the set value, the feedback power source circuit reduces the amount of supplying the current to the internal circuits. In this way, the feedback power source circuit stabilizes the internal power source voltage VINT.

However, there is a limit to a response rate of the feedback power source circuit to the variation in the internal power source voltage VINT. If the current consumption has a rapid increase, the internal power source voltage VINT suddenly drops. At this time, if the feedback power source circuit cannot sufficiently supply the current to catch up with the rapid variation and the internal power source voltage VINT falls below a set value, the semiconductor device possibly malfunctions. For example, if the OCD outputs data at a high rate and a transition frequency of the output data is high, the power consumption of the OCD rapidly increases. In this case, the feedback power source circuit often cannot sufficiently compensate for the current consumption of the OCD.

### BRIEF DESCRIPTION OF THE DRAWINGS

FIG. 1 is a block diagram showing a configuration of a semiconductor device according to a first embodiment;

FIG. 2 shows configurations of a prefetch circuit PFC and an off chip driver OCD;

FIG. 3 is a circuit diagram showing a configuration of the kicker power source circuit KPS;

FIG. 4 is a circuit diagram showing a configuration of the kicker control circuit KCC according to the first embodiment;

FIG. 5 is a timing diagram showing an output operation performed by the semiconductor device according to the first embodiment;

FIG. 6 is a timing diagram showing an operation performed by the kicker control circuit KCC;

FIG. 7 is a circuit diagram showing a configuration of the kicker control circuit KCC included in a semiconductor device according to a second embodiment;

FIG. 8 is a timing diagram showing an operation performed by the semiconductor device according to the second embodiment;

FIG. 9 is a circuit diagram showing a configuration of the kicker control circuit KCC included in a semiconductor device according to a third embodiment;

FIG. 10 is a timing diagram showing an operation performed by the semiconductor device according to the third embodiment;

FIG. 11 is a circuit diagram showing a configuration of the kicker control circuit KCC included in a semiconductor device according to a fourth embodiment;

FIGS. 12 and 13 are timing diagrams showing an operation performed by a semiconductor device according to the fourth embodiment;

FIG. 14 is a circuit diagram showing a configuration of the kicker control circuit KCC included in a semiconductor device according to a fifth embodiment;

FIG. 15 shows how the off chip driver OCD operates in an output high impedance state;

FIG. 16 is a timing diagram showing an operation performed by the semiconductor device according to the fifth embodiment;

FIG. 17 is a circuit diagram showing a configuration of the kicker control circuit KCC included in a semiconductor device according to a sixth embodiment;

FIG. 18 is a timing diagram showing an output operation performed by the semiconductor device according to the sixth embodiment;

FIG. 19 is a block diagram showing configurations of the kicker control circuit KCC and kicker power source circuits KPS according to a seventh embodiment; and

FIG. 20 is a circuit diagram showing a configuration of each of the rear portions KCCb_01 to KCCb_67 of the kicker control circuit KCC.

### DETAILED DESCRIPTION

In a semiconductor device according to embodiments of the present invention, a core circuit is constituted by an integrated circuit. A peripheral circuit includes a driver that receives a voltage from an internal power source and a voltage from an external power source and that outputs digital data transferred from the core circuit, and a fetch portion that temporarily holds the digital data from the core circuit and that transfers the digital data to the driver. A first power source portion supplies an internal voltage to the driver via a power source line. A second power source portion includes a plurality of current driving strings each including a current driving element and a switching element connected in series between the external power source and the power source line. The second power source portion supplies a current to the power source line separately from the first power source portion by driving the current driving strings. A power source controller controls the second power source portion to drive at least one of the current driving strings when a logic transition occurs among consecutive bits of the digital data.

Embodiments will now be explained with reference to the accompanying drawings.

### First Embodiment

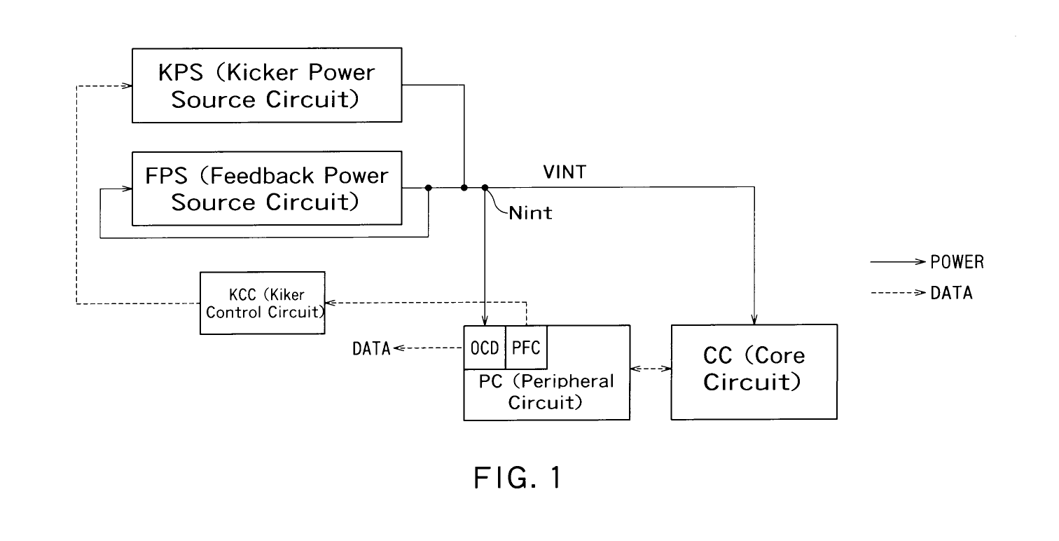

FIG. 1 is a block diagram showing a configuration of a semiconductor device according to a first embodiment of the present invention. The semiconductor device according to the first embodiment includes a core circuit CC, a peripheral circuit PC, a feedback power source circuit FPS as the first power source portion, the kicker power source circuit KPS as the second power source portion, and a kicker control circuit KCC as the power source controller. The core circuit CC is an integrated circuit device that operates upon receiving an internal power source voltage VINT. While the core circuit CC is not limited to a specific type, the core circuit CC includes, for example, memory cells and a circuit driving the memory cells. In FIG. 1, a solid line indicates a flow of a power source voltage and a broken line indicates a flow of data.

The peripheral circuit PC is configured to either control the core circuit CC in response to an external command or to store data input from outside in the core circuit CC. The peripheral circuit PC is also configured to output data stored in the core circuit CC to the outside. The peripheral circuit PC operates with the internal power source voltage VINT.

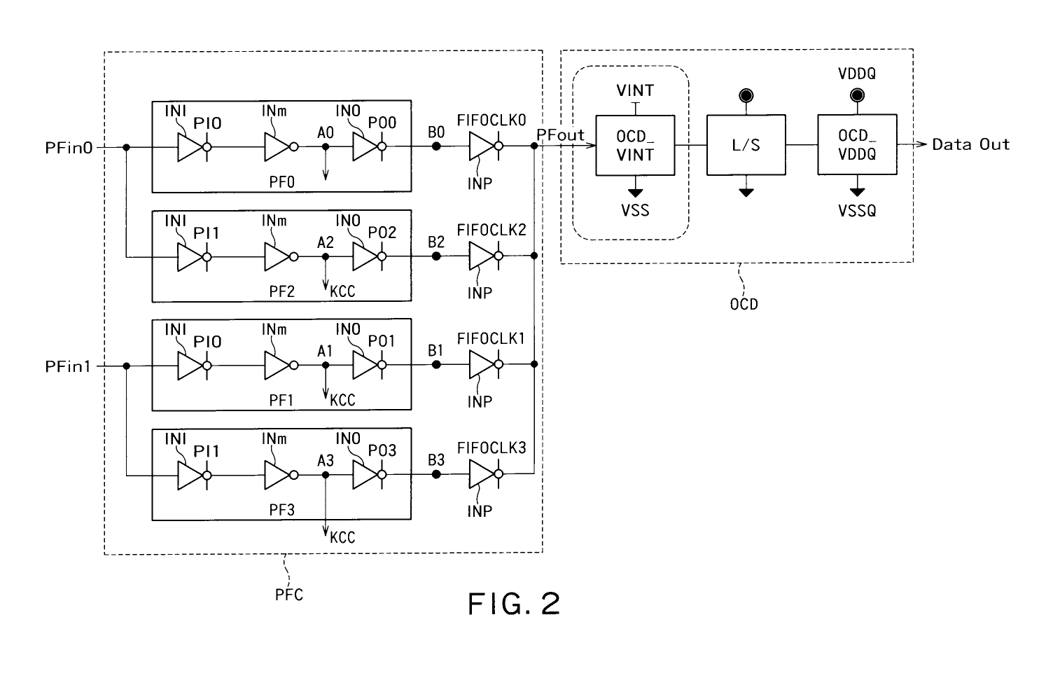

FIG. 2 shows configurations of a prefetch circuit PFC and an off chip driver OCD. The peripheral circuit PC includes the prefetch circuit PFC and the off chip driver OCD. The prefetch circuit PFC receives data from the core circuit CC or the peripheral circuit PC at input sections PFin0 and PFin1. The prefetch circuit PFC includes prefetch sections PF0 to PF3 temporarily holding data. Each of the prefetch sections PF0 to PF3 includes an input-side clocked inverter INI, an intermediate inverter INm, and an output-side clocked inverter INO connected in series. The prefetch sections PF0 to PF3 can temporarily fetch and hold data in nodes A0 to A3 between the clocked inverters INI and INO, respectively according to clock signal (input clock) PI0 or PI1. The prefetch circuit PFC also includes clocked inverters INP connected to output portions of the prefetch sections PF0 to PF3, respectively. The prefetch sections PF0 to PF3 can also temporarily fetch and hold data in nodes B0 to B3 between the clocked inverters INO and INP according to clock signals PO0 to P03, respectively.

An output portion PFout common to the clocked inverters INP is connected to the off chip driver OCD. This enables the prefetch circuit PFC to transfer data to the off chip driver OCD. The data output from the prefetch circuit PFC is digital data of consecutive A0, A1, A2, A3, A0, A1, A2, A3 . . . . Note that data in a node Ai (where i is an integer) is denoted simply by “Ai”. Similarly, data in the node Ai may be often simply denoted by “Ai”, hereinafter.

The nodes A0 to A3 are also connected to the kicker control circuit KCC. This enables the prefetch circuit PFC to also output the data A0 to A3 to the kicker control circuit KCC.

The prefetch circuit PFC outputs the data input to the input sections PFin0 and PFin1 at a double rate. That is, the prefetch circuit PFC transfers data at DDR (Double Data Rate).

The off chip driver OCD includes a first driver OCD_VINT to which the data from the output portion PFout of the prefetch circuit PFC is input and which controls and transfers this data using the internal power source voltage VINT, a level shifter L/S amplifying a signal voltage level of the data from an internal power source voltage VINT−VSS to an external power source voltage VDDQ−VSSQ (VDDQ>VINT, generally VSSQ=VSS), and a second driver OCD_VDDQ finally outputting the data with external power source voltages VDDQ and VSSQ. The second driver OCD_VDDQ outputs the amplified data. The data output from the off chip driver OCD is output to the outside via an I/O pad (not shown).

Referring back to FIG. 1, the feedback power source circuit FPS and the kicker power source circuit KPS supply the internal power source voltage VINT to the core circuit CC and the peripheral circuit PC. The feedback power source circuit FPS mainly supplies the internal power source voltage VINT. The feedback power source circuit FPS is configured to feed back the internal power source VINT so as to follow up a variation in the internal power source voltage VINT.

If a data transition frequency is high, current consumption of the first driver OCD_VINT increases. The data transition means that the logic among a plurality of consecutive bits changes from “0” to “1” or from “1” to “0”. Accordingly, if the output data is a continuation of the same digital value of “0000 . . . ” or “1111 . . . ”, the current consumption of the off chip driver OCD is low. However, if the output data is “010101 . . . ” the logic transition frequency among which is high, the current consumption of the off chip driver OCD is high.

Moreover, if the prefetch circuit PFC outputs data at a high rate such as the DDR, the current consumption of the first driver OCD_VINT further increases. In a case like this, the feedback power source circuit FPS cannot follow up the rapid variation in the internal power source voltage VINT, often resulting in a decrease in the internal power source voltage VINT.

Therefore, according to the first embodiment, to follow the variation in the internal power source voltage VINT, the kicker power source circuit KPS in addition to the feedback power source circuit FPS supplies the current to the core circuit CC and the peripheral circuit PC via a node Nint according to the output data.

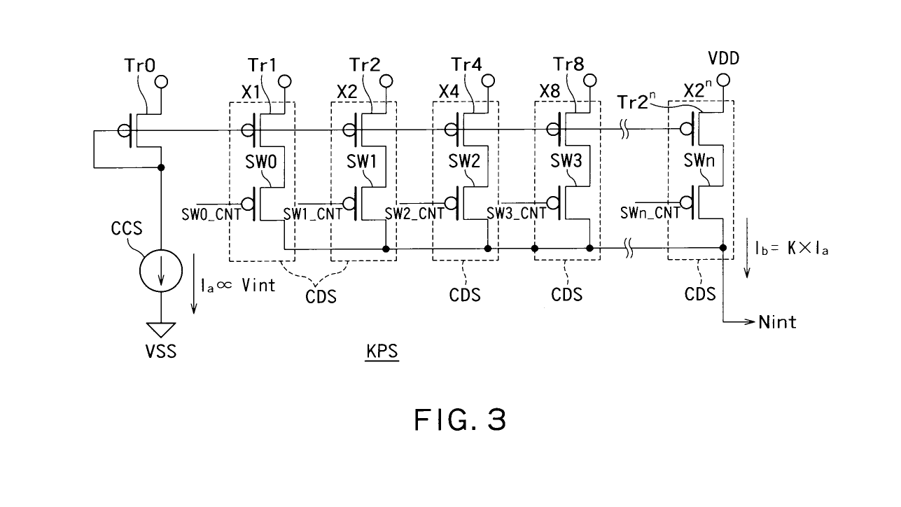

FIG. 3 is a circuit diagram showing a configuration of the kicker power source circuit KPS. The kicker power source circuit KPS is configured to multiply a current Ia carried in a transistor Tr0 by K and to supply the resultant current to the core circuit CC and the peripheral circuit PC. More specifically, the kicker power source circuit KPS includes transistors Tr0 to Tr2ⁿ as current driving elements, and switching elements SW0 to SWn. The switching elements SW0 to SWn correspond to the transistors Tr1 to Tr2ⁿ, respectively. One switching element SWi (0≦i≦n) and the corresponding transistor Tr2ⁱ are connected in series between an external power source VDD and the off chip driver OCD (the node Nint) and constitute one current driving string CDS. A plurality of current driving strings CDS are connected in parallel between the external power source VDD and the node Nint. Accordingly, each of the transistors Tr1 to Tr2ⁿ is connected to the node Nint via the switching elements SW0 to SWn, respectively. Other ends of the transistors Tr1 to Tr2ⁿ are connected to the external power source VDD. Gates of the transistors Tr1 to Tr2ⁿ are connected in common to a gate of the transistor Tr0.

A current drivability of one transistor Tr2ⁿ is 2ⁿ times as high as that of the transistor Tr0. It is possible to adjust the current drivability of the transistor Tr2ⁿ by changing a size. For example, if a channel length is constant, it is possible to set the current drivability of the transistor Tr2ⁿ by changing a channel width.

The transistor Tr0 is connected between the external power source VDD and a constant-current source CCS and connected to a ground potential VSS via the constant-current source CCS. The gate of the transistor Tr0 as well as a source thereof is connected to the constant-current source CCS. The constant-current source CCS carries the current Ia in proportion to the set internal power source voltage and a voltage of the gate of the transistor Tr0 depends on the current Ia. Accordingly, current drivability of the Tr1 to Tr2ⁿ having gates connected to the transistor Tr0 in common are ideally equal per unit gate width and proportional to the current Ia.

With this configuration, the kicker current source circuit KPS determines a supply current Ib (Ib=K×Ia) by controlling the switching elements SW0 to SWn, and supplies the supply current Ib to the node Nint. For example, if a current drivability ratio of the Tr0 to the Tr1 is L and only the switching element SW2 is turned on, the kicker power source circuit KPS supplies the current Ib of 4L×Ia (K=4L) to the node Nint. That is, the kicker current source circuit KPS supplies the current Ib proportional to the original current Ia to the node Nint by mirroring the current Ia.

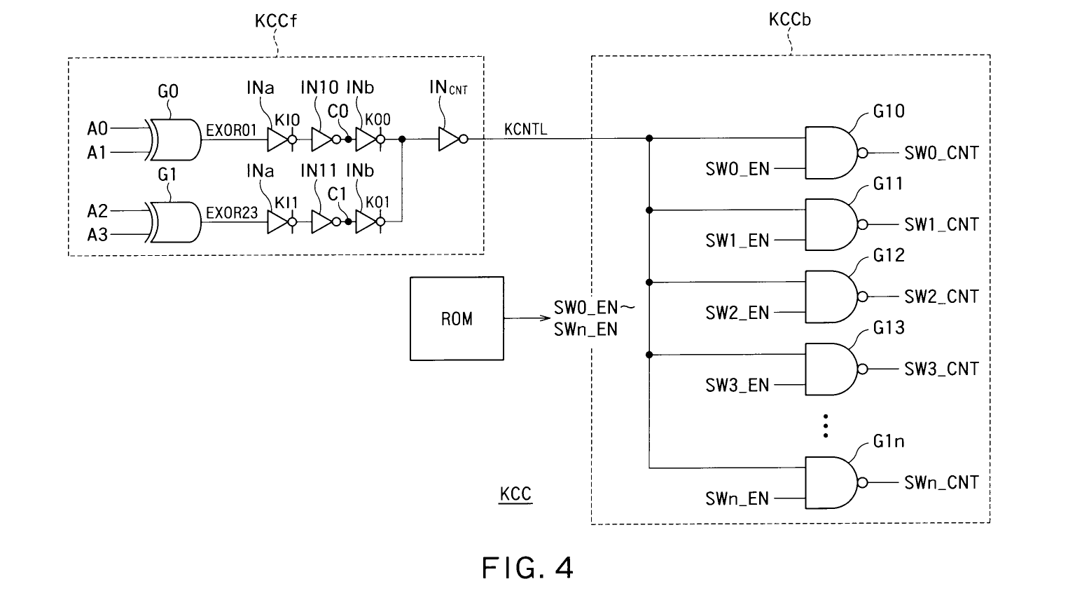

FIG. 4 is a circuit diagram showing a configuration of the kicker control circuit KCC according to the first embodiment.

The kicker control circuit KCC is connected between the prefetch circuit PFC and the kicker power source circuit KPS, and controls conductive states of the switching elements SW0 to SWn included in the kicker power source circuit KPS according to data held in the nodes A0 to A3 of the prefetch circuit PFC. This enables the kicker control circuit KCC to control driving states (on/off states) of the current driving strings CDS, respectively.

The kicker control circuit KCC includes EXOR gates G0 and G1, input-side clocked inverters INa, inverters IN10 and IN11, output-side clocked inverters INb, NAND gates G10 to G1n, and a ROM (Read Only Memory). The gate G0 receives the data held in the nodes A0 and A1 from the prefetch circuit PFC shown in FIG. 1, and outputs an exclusive-OR between the data as EXOR01. The gate G1 receives the data held in the nodes A2 and A3, and outputs an exclusive-OR between the data as EXOR23.

The clocked inverter INa, the inverter IN10 (or IN11), and the clocked inverter INb are connected in series, and are connected between the gates G0 or G1 and an inverter INcnt. The clocked inverters INa connected to the gates G0 and G1 transfer data EXOR01 and EXOR23 to nodes C0 and C1 at different timings, respectively. The nodes C0 and C1 hold the data EXOR01 and EXOR23, respectively. The clocked inverters INb connected to the nodes C0 and C1 transfer the data temporarily fetched in the nodes C0 and C1 to the inverter INcnt at different timings, respectively. The inverter INcnt inverts the data transferred from the clocked inverters INb and outputs the inverted data to the gates G10 to G1n as a control signal KCNTL. That is, the data equal in logic to the data EXOR01 and EXOR23 at a timing of being fetched in the nodes C0 and C1 is transferred as the control signal KCNTL.

The kicker control circuit KCC according to the first embodiment activates the control signal KCNTL to be logically high if the data differs between the nodes A0 and A1 or if the data differs between the nodes A2 and A3. For example, if the nodes A0 and A1 hold “0” and “1” or “1” and “0”, respectively, the kicker control circuit KCC activates the output signal EXOR01 from the gate G0 to be logically high. If the nodes A2 and A3 hold “0” and “1” or “1” and “0”, respectively, the kicker control circuit KCC activates the output signal EXOR23 from the gate G1 to be logically high.

The output signal EXOR01 is held in the node C0 at a timing where the kicker clock signal KI0 is activated. The output signal EXOR23 is held in the node C1 at a timing where the kicker clock signal KI1 is activated.

The data EXOR01 fetched according to the kicker clock signal KI0 is output to the gates G10 to G1n as the kicker control signal KCNTL at a timing where a kicker clock signal KO0 is activated. The data EXOR23 fetched according to the kicker clock signal KI1 is output to the gates G10 to Gin as the kicker control signal KCNTL at a timing where a kicker clock signal KO1 is activated.

The gates G10 to G1n receive the control signal KCNTL and switch enable signals SW0_EN to SWn_EN, and output NAND results thereof as switch control signals SW0_CNT to SWn_CNT, respectively. The switch control signals SW0_CNT to SWn_CNT are input to gates of the switching elements SW0 to SWn shown in FIG. 3 to control the switching elements SW0 to SWn to be turned on or off, respectively.

If the control signal KCNTL is activated to be logically high, at least one of the gates G10 to G1n activates corresponding one of the switch control signals SW0_CNT to SWn_CNT according to switch enable signals SW0_EN to SWn_EN. For example, it is assumed that only the switch enable signal SW2_EN is activated to be logically high and that other switch enable signals SW0_EN, SW1_EN, SW3_EN . . . and SWn_EN are deactivated to be logically low. In this case, only the gate G12 activates the switch control signal SW2_CNT to be logically low and other gates G10, G11, G13 . . . and G1n are deactivated to be logically high while the control signal KCNTL is logically high. As a result, only the switching element SW2 shown in FIG. 3 is made conductive and the transistor Tr4 supplies a current from the power source VDD to the node Nint. In this case, K=4L and Ib=4L×Ia. The kicker control circuit KCC can make a plurality of switching elements conductive among the switching elements SW0 to SWn according the swich enable signals.

Data of the switch enable signals SW0_EN to SWn_EN is stored in the ROM in advance. The switch enable signal SWi_EN (i:0 to n) is a digital value preset according to a current drivability of the kicker power source circuit KPS necessary for a product. For example, a value of the switch enable signal SW0_EN can be set in a design phase of the semiconductor device according to the first embodiment or set according to the internal power source voltage VINT measured after manufacturing the semiconductor device. As shown in the example above, if only the switching element SW2 is made conductive, the switch enable signals SW0_EN to SWn_EN are “00100 . . . 0”. Alternatively, the switch enable signal SWi_EN can be obtained by logical calculation between input data stored in the ROM and a certain operation control signal.

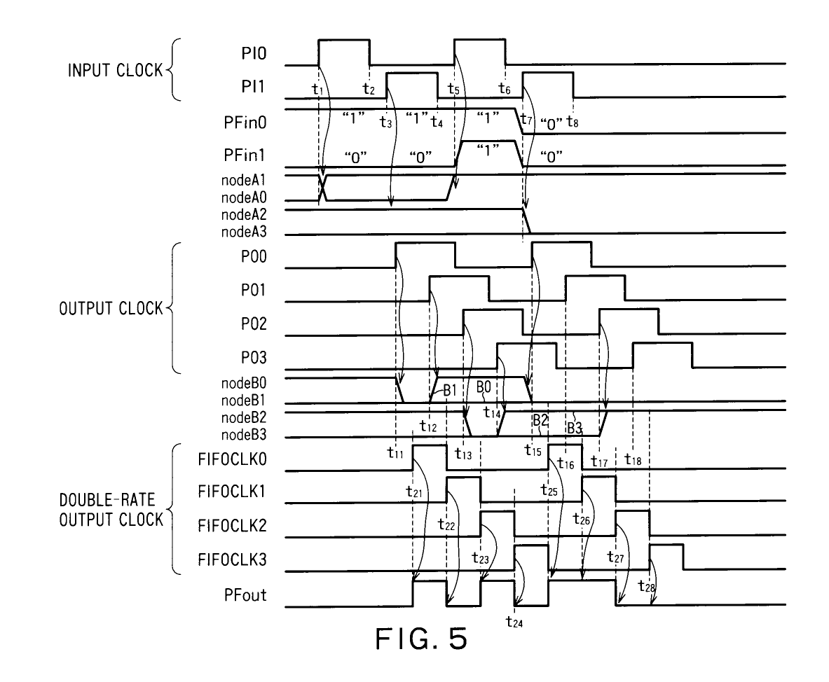

FIG. 5 is a timing diagram showing an output operation performed by the semiconductor device according to the first embodiment. Fetch clock signals (input clock signals) PI0 and PI1 are signals input to the clocked inverters INI and alternately activated. Accordingly, the prefetch sections PF0 and PF1 and the prefetch sections PF2 and PF3 shown in FIG. 2 alternately fetch data. For example, from t1 to t2, the fetch clock signal PI0 is activated. Therefore, the prefetch section PF0 receives logically high data (“1”) from the input portion PFin0. At the same time, the prefetch section PF1 receives logically low data (“0”) from the input portion PFin1. These pieces of data are held in the nodes A0 and A1 included in the prefetch sections PF0 and PF1, respectively. At this moment, output clock signals PO0 to PO3 are deactivated to be logically low. Accordingly, the clocked inverters INO shown in FIG. 2 are in states of holding data in the nodes A0 to A3, respectively and do not output the data.

From t3 to t4, the fetch clock signal PI1 is activated. Therefore, the prefetch section PF2 receives logically high data (“1”) from the input portion PFin0 and the prefetch section PF3 receives logically low data (“0”) from the input portion PFin1. In this example, the prefetch sections PF2 and PF3 fetch the same data as that fetched by the prefetch sections PF0 and PF1, respectively. Alternatively, the prefetch sections PF2 and PF3 can fetch different data from that fetched by the prefetch sections PF0 and PF1, respectively. In this alternative, pieces of data input from the input portions PFin0 and PFin1 are changed after the fetch clock signal PI0 is deactivated at t2 and before the fetch clock signal PI1 is deactivated at t4. These pieces of data are held in the nodes A2 and A3 included in the prefetch sections PF2 and PF3, respectively. At this moment, the nodes A0 to A3 hold “1010”. The data “1010” held in the nodes A0 to A3 is also transferred to the kicker control circuit KCC.

Right after the fetch clock signal PI0 is deactivated at t2, the output clock signals PO0 and P01 are sequentially activated at t11 and t12. The data stored in the nodes A0 and A1 is thereby sequentially transferred to the nodes B0 and B1, respectively. Further, right after the fetch clock signal PI1 is deactivated at t4, the output clock signals PO2 and PO3 are sequentially activated at t13 and t14. The data stored in the nodes A2 and A3 is thereby sequentially transferred to the nodes B2 and B3, respectively. Since the nodes B2 and B3 hold data in a state of inverting the data held in the nodes A2 and A3, respectively, the nodes B0 to B3 hold “0101”.

From t21 to t24, double rate output clocks FIFOCLK0 to FIFOCLK3 are sequentially activated. The clocked inverters INP thereby sequentially invert the data “0101” held in the nodes B0 to B3 and output inverted data from the output portion PFout. Accordingly, the output portion PFout outputs data “1010” equal in logic to the data input from the input portions PFin0 and PFin1 in parallel. The double rate output clocks FIFOCLK0 to FIFOCLK3 rise with a double operating frequency as compared with that of the fetch clocks PI0 and PI1. Accordingly, the prefetch circuit PFC transfers the data from the input portions PFin0 and PFin1 to the off chip driver OCD at double date rate as compared with that of the fetch clock signals PI0 and PI1.

Operations from t5 to t8 are repetition of those from t1 to t4 except that data input from the input portions PFin0 and PFin1 is “1100”. Accordingly, from t5 to t8, the prefetch sections PF0 to PF3 hold “1100” in the nodes A0 to A3, respectively. From t15 to t18, the prefetch sections PF0 to PF3 hold “0011” in the nodes B0 to B3, respectively. From t25 to t28, the prefetch sections PF0 to PF3 output data “1100” from the output portion PFout.

By repeatedly performing the operation described above, the prefetch circuit PFC transfers the data to the off chip driver OCD at the double rate as compared with the internal data transfer rate.

To activate means to turn on or drive an element or a circuit and to deactivate means to turn off or stop an element or a circuit. Therefore, a HIGH (high potential level) signal is an activation signal on one occasion and a LOW (low potential level) signal is an activation signal on another occasion. For example, an NMOS transistor is activated by setting a gate thereof HIGH. A PMOS transistor is activated by setting a gate thereof LOW.

The off chip driver OCD receives the output data from the prefetch circuit PFC, controls this output data with the internal power source voltage VINT and the like, and amplifies a signal voltage level of the data. Further, the off chip driver OCD outputs the amplified data to outside of a chip.

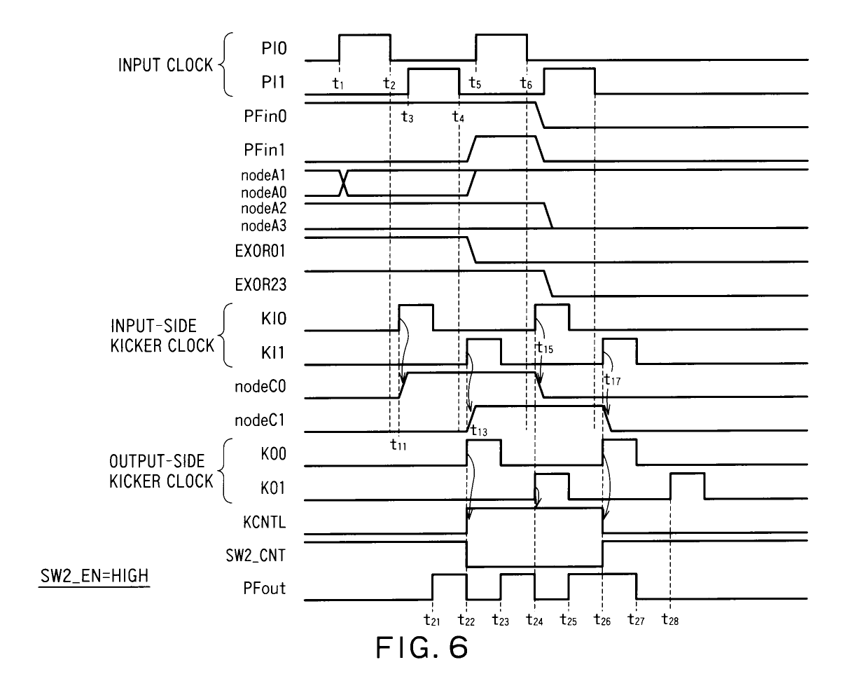

FIG. 6 is a timing diagram showing an operation performed by the kicker control circuit KCC. Operations related to data on fetch clocks PI0 and PI1, data input to the input portions PFin0 and PFin1, and the data held in the nodes A0 to A3 are identical to those shown in FIG. 5.

The kicker control circuit KCC receives the data held in the nodes A0 to A3. The kicker control circuit KCC transfers the exclusive-OR (EXOR01) between the data in the nodes A0 and A1 to the node C0 at the timing of activating the input-side kicker clock KI0 (at t11). In addition, the kicker control circuit KCC transfers the exclusive-OR (EXOR23) between the data in the nodes A2 and A3 to the node C1 at the timing of activating the input-side kicker clock KI1 (at t13). If the data held in the node A0 differs from that held in the node A1, the output signal EXOR01 is a signal activated to be logically high. If the data held in the node A2 differs from that held in the node A3, the output signal EXOR23 is a signal activated to be logically high. The input-side kicker clocks KI0 and KI1 are signals activated right after deactivating the fetch clocks PI0 and PI1, respectively.

At the timing of t13, the data held in the nodes C0 and C1 are activated to be logically high.

After deactivating the input-side kicker clock KI0, the output-side kicker clock KO0 is activated (t22), and the data held in the node C0 is output to the gates G10 to G1n as the kicker control signal KCNTL. At this time, the node C0 is logically high, so that the kicker control signal KCNTL is activated to be logically high. Accordingly, the gates G10 to G1n output the switch control signals SW0_CNT to SWn_CNT according to the switch enable signals SW0_EN to SWn_EN, respectively. For example, if only the switch enable signal SW0_EN is set to be logically high (active) and the other enable signals SWi_EN (i≠2) are set to be logically low (inactive), the kicker control circuit KCC activates only the switch control signal SW2_CNT to be logically low at t22. The switch control signals other than the switch control signal SW2_CNT are kept logically high. This enables the kicker power source circuit KPS shown in FIG. 3 to supply the current 4L×Ia to the node Nint.

After deactivating the input-side kicker clock KI1, when the output-side kicker clock KO1 rises (t24), the node C1 is logically high. Therefore, the kicker control signal KCNTL is kept logically high. Accordingly, the switch control signal SW2_CNT is kept logically low, and the kicker power source circuit KPS shown in FIG. 3 continues to supply the current 4L×Ia to the node Nint. In this way, the kicker control circuit KCC detects a transition of a logical value of the output signal PFout and the kicker power source circuit KCC supplies a current according to the transition of the data.

Further, at t15, the input-side kicker clock KI0 rises and the output signal EXOR01 (logically low) is fetched in the node C0. At t17, the input-side kicker clock KI1 rises and the output signal EXOR23 (logically low) is fetched in the node C1.

After t15, when the output-side kicker clock KO0 rises (t26), the node C0 is logically low. Therefore, the kicker control signal KCNTL is changed to be logically low. Accordingly, the switch control signal SW2_CNT is deactivated to be logically high and the kicker power source circuit KPS is turned off. That is, at t26, where no data transition of the output signal PFout occurs, the kicker power source circuit KPS does not supply any current to the node Nint.

After t17, when the output-side kicker clock KO1 rises (t28), the node C1 is logically low. Therefore, the kicker control signal KCNTL is kept logically low. Accordingly, the switch control signal SW2_CNT is kept logically high and the kicker power source circuit is kept to be turned off. That is, since there is no data transition of the output signal PFout at t28, the kicker power source circuit KPS does not supply any current to the node Nint.

The input-side kicker clocks KI0 and KI1 rise at the same timings where the output clocks PO0 and PO2 shown in FIG. 5 rise, respectively. However, if no problem occurs to fetching of the EXOR01 and EXOR23, the rising timings of the input-side kicker clocks KI0 and KI1 can be set different from those of the output clocks PO0 and PO2, respectively. Further, the output-side kicker clocks KO0 and KO1 rise at the same timings where the double rate output clocks FIFOCLK0 and FIFOCLK1 shown in FIG. 5 rise, respectively. However, if no problem occurs to the variation in the internal power source voltage VINT, the rising timings of the output-side kicker clocks KO0 and KO1 can be set different from those of the double rate output clocks FIFOCLK0 and FIFOCLK1, respectively.

In this way, according to the first embodiment, the kicker control circuit KCC drives the kicker power source circuit KPS according to the transition of the data transferred to the off chip driver OCD. The kicker power source circuit KPS supplies the current Ib to the node Nint under the control of the kicker control circuit KCC. If current consumption is high during the transition of the data output from the output portion PFout of the prefetch circuit PFC and the feedback power source circuit FPS cannot supply a sufficient current, the kicker power source circuit KPS supplies the current Ib to compensate for the current consumption, thereby supporting the feedback power source circuit FPS. This can prevent the voltage in the node Nint from greatly changing from Vint. As a result, the feedback power source circuit FPS and the kicker power source circuit KPS according to the first embodiment can follow up the rapid variation in the internal power source voltage Vint and supply stable internal power source voltage Vint.

If the kicker control circuit KCC receives the data in order of the nodes A0, A1, A2, A3, A0, A1, A2, A3, . . . , the kicker control circuit KCC detects a transition of data held in the node A0 to that in the node A1 but does not detect the next transition of the data held in the node A1 to that in the node A2. Similarly, the kicker control circuit KCC detects a transition of data held in the node A2 to that in the node A3 but does not detect the next transition of the data held in the node A3 to that in the node A0. That is, the kicker control circuit KCC detects the transition among the consecutive bits in the nodes A0, A1, A2, A3 . . . intermittently (alternately). This can make the kicker control circuit KCC small in circuit scale.

In the first embodiment, the number of prefetch units included in one prefetch circuit PFC is four (PF0 to PF3) as shown in FIG. 4. Alternatively, the number of prefetch units included in one prefetch circuit PFC may be two or an even number equal to or greater than six. In this alternative, it suffices to increase the number of exclusive-OR gates Gi (where i is an integer) and that of clocked inverters INa and INb included in the kicker control circuit KCC according to the number of nodes Aj (where j is an even number).

The kicker control circuit KCC according to the first embodiment uses the data in the prefetch circuit PFC so as to detect the transition of data output from the output portion PFout. Alternatively, the kicker control circuit KCC can use the data fetched in an upstream circuit of the prefetch circuit PFC. That is, the kicker control circuit KCC can fetch data before being input to the prefetch circuit PFC and detect a transition of the data. In that case, the kicker control circuit KCC and the kicker power source circuit KPS can be given sufficient time to supply a current by as much as the current consumption of the off chip driver OCD.

The configuration of the kicker control circuit KCC shown in FIG. 4 is given only as an example and, in the first embodiment, the kicker control circuit KCC can use other logical circuits that perform operations in the same way as the circuits shown in FIG. do. 4.

### Second Embodiment

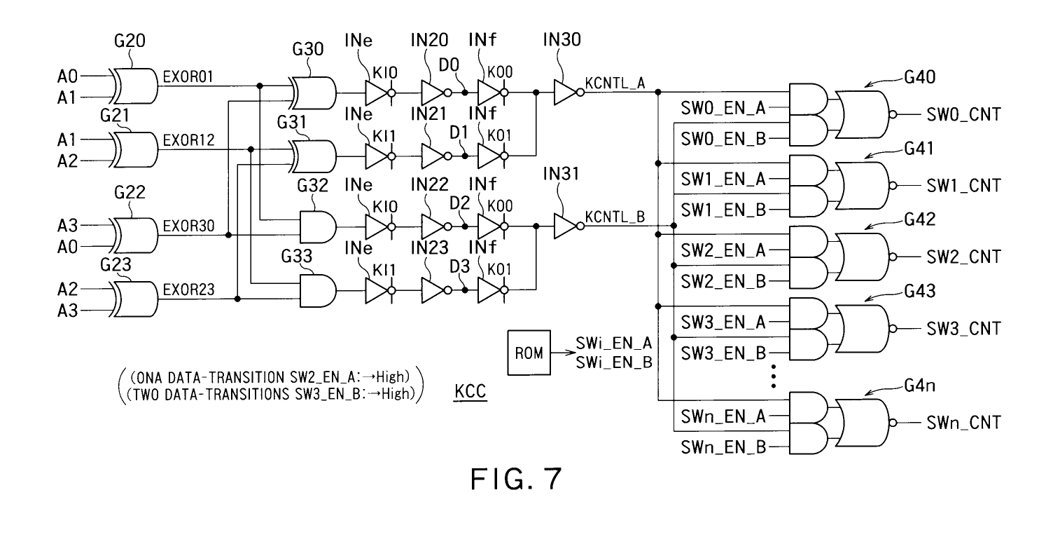

FIG. 7 is a circuit diagram showing a configuration of the kicker control circuit KCC included in a semiconductor device according to a second embodiment of the present invention. In the second embodiment, the kicker control circuit KCC detects all transitions of digital data output consecutively from the core circuit CC. In the first embodiment, the kicker control circuit KCC detects a transition of two consecutive data fetched in the prefetch circuit PFC at the same timing, thereby driving the kicker power source circuit KPS. In the second embodiment, the kicker control circuit KCC controls the kicker power source circuit KPS to change an output current between an instance of one data transition and an instance of two data transitions for three consecutive data including data fetched in a prefetch circuit PFC at different timings. Configurations of the semiconductor device according to the second embodiment can be same as those described in the first embodiment, except for the kicker control circuit KCC.

The kicker control circuit KCC according to the second embodiment includes exclusive-OR gates G20 to G23, G30, and G31, AND gates G32 and G33, gate circuits G40 to G4n, clocked inverters INe and INf, and inverters IN20 to IN23, IN30, and IN31. Each of the gate circuits G40 to G4n includes two AND gates and a NOR gate receiving outputs from the AND gates.

The gates G20 to G23 receive data in nodes A0 and A1, that in nodes A1 and A2, that in nodes A3 and A0, and that in nodes A2 and A3, respectively. The gates G20 to G23 output exclusive-ORs between the input data, respectively. A data transition from A0 to A1 is denoted by EXOR01, that from A1 to A2 is denoted by EXOR12, that from A2 to A3 is denoted by EXOR23, and that from A3 to A0 is denoted by EXOR30.

Each of the gates G30 and G32 receives both of output signals EXOR01 and EXOR30. The gate 30 detects that one of the output signals EXOR01 and EXOR30 is activated to be logically high. The gate 32 detects that both of the output signals EXOR01 and EXOR30 are activated to be logically high.

If there is a data transition either between the nodes A0 and A1 or between the nodes A3 and A0, the gate G30 outputs logically high data. That is, if one data transition (such as 100, 110, 001 or 011) occurs among three consecutive digital data such as A3, A0, and A1, the gate G30 outputs the logically high data. In this case, the gate G32 outputs logically low data. An output from the gate G30 is input to the gates G40 to G4n via the clocked inverter INe, the inverter IN20, and the clocked inverter INf as a kicker control signal KCNTL_A. The gates G40 to G4n receive the kicker control signal KCNTL_A, and output switch control signals SW0_CNT to SWn_CNT according to switch enable signals SW0_EN_A to SWn_EN_A, respectively. For example, to activate only the switch control signal SW0_CNT to be logically low, it suffices to set digital data of the switch enable signals SW0_EN_A to SWn_EN_A to 001000 . . . . As already described with reference to FIG. 4, the digital data of the switch enable signals SW0_EN_A to SWn_EN_A can be stored in a ROM. In this case, the kicker power source circuit KPS supplies a current Ib1 of 4L×Ia to a node Nint.

If there are data transitions both between the nodes A0 and A1 and between the nodes A3 and A0, respectively, the gate G32 outputs logically high data. That is, if two data transitions (such as 101 or 010) occur among the three consecutive digital data such as A3, A0, and A1, the gate G32 outputs the logically high data. In this case, the gate G30 outputs logically low data. The output from the gate G32 is input to the gates G40 to G4n via the clocked inverter INe, the inverter IN22, and the clocked inverter INf as a kicker control signal KCNTL_B. The gates G40 to G4n receive the kicker control signal KCNTL_B, and output switch control signals SW0_CNT to SWn_CNT according to switch enable signals SW0_EN_B to SWn_EN_B, respectively. For example, to activate only the switch control signal SW3_CNT to be logically low, it suffices to set digital data of the switch enable signals SW0_EN_B to SWn_EN_B to 0001000 . . . . The digital data of the switch enable signals SW0_EN_B to SWn_EN_B can be stored in the ROM. In this case, the kicker power source circuit KPS supplies a current Ib2 of 8L×Ia to the node Nint.

Similarly, if there is a data transition either between the nodes A1 and A2 or between the nodes A2 and A3, the gate G31 outputs logically high data and the gate G33 outputs logically low data. That is, if one data transition (such as 100, 110, 001 or 011) occurs among three consecutive digital data such as A1, A2, and A3, the gate G31 outputs the logically high data. The gates G40 to G4n thereby receive the kicker control signal KCNTL_A, and output the switch control signals SW0_CNT to SWn_CNT according to the switch enable signals SW0_EN_A to SWn_EN_A, respectively.

If there are data transitions both between the nodes A1 and A2 and between the nodes A2 and A3, respectively, the gate G33 outputs logically high data and the gate G31 outputs logically low data. That is, if two data transitions (such as 101 or 010) occur among the three consecutive digital data such as A1, A2, and A3, the gate G33 outputs the logically high data. The gates G40 to G4n thereby receive the kicker control signals KCNTL_B, and output the switch control signals SW0_CNT to SWn_CNT according to the switch enable signals SW0_EN_B to SWn_EN_B, respectively.

The current Ib2 (Ib2=8L×Ia) supplied by the kicker power source circuit KPS if the two data transitions occur among the three consecutive digital data is twice as high as the current Ib1 (Ib1=4L×Ia) supplied by the kicker power source circuit KPS if one data transition occurs. Therefore, even if many transitions occur among the output data, the kicker power source circuit KPS can supply a sufficient current to compensate for current consumption of the off chip driver OCD.

The current Ib2 is not limited to the current twice as high as the current Ib1. The current Ib2 can be set to an arbitrary current higher than the current Ib1 according to the current consumption of the off chip driver OCD.

The configuration of the kicker control circuit KCC shown in FIG. 7 is given only as an example and, in the second embodiment, the kicker control circuit KCC can use other logical circuits that perform operations in the same way as the circuits shown in FIG. 7 do.

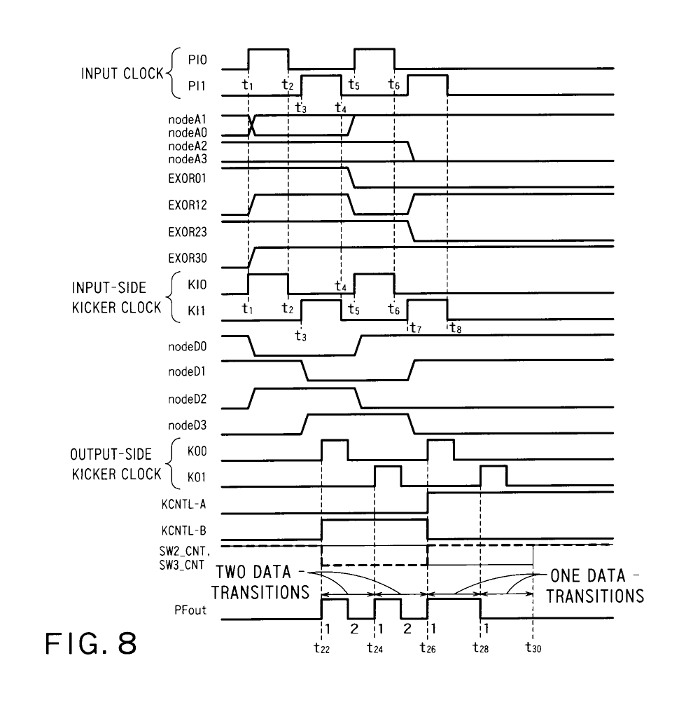

FIG. 8 is a timing diagram showing an operation performed by the semiconductor device according to the second embodiment. Operations related to data on fetch clocks PI0 and PI1, data input to input portions PFin0 and PFin1, and data held in the nodes A0 to A3 are identical to those shown in FIG. 5. FIG. 8 does not show the operations related to the data input to the input portions PFin0 and PFin1.

Signals EXOR01 to EXOR30 are determined according to the logical states of the data in the nodes A0 to A3.

From t1 to t2, an input-side kicker clock KI0 is activated, whereby outputs from the gates G30 and G32 are held in nodes D0 and D2 shown in FIG. 7, respectively. The data in the nodes A0 and A1 and that in the nodes A3 and A0 are “10” and “01”, respectively. Accordingly, the EXOR01 and EXOR30 are logically high, and the nodes D0 and D2 hold logically low data and logically high data, respectively.

After t2, an output-side kicker clock KO0 is activated (t22), and the data held in the nodes D0 and D2 is output as the control signals KCNTL_A and KCNTL_B, respectively. Accordingly, the control signal KCNTL_A is deactivated to be logically low and the control signal KCNTL_B is activated to be logically high. As a result, from t22 to t24, the kicker control circuit KCC activates only the switch control signal SW3_CNT to be logically low. Accordingly, the kicker power source circuit KPS supplies the current 8L×Ia to the node Nint. In this way, if the two data transitions such as “010” occur among the three consecutive logic data in the nodes A3, A0, and A1, the kicker power source circuit KPS supplies a relatively high current to the node Nint.

From t3 to t4, an input-side kicker clock KI1 is activated, whereby outputs from the gates G31 and G33 are held in nodes D1 and D3 shown in FIG. 7, respectively. After t4, an output-side kicker clock KO1 is activated (t24), and the data held in the nodes D1 and D3 is output as the control signals KCNTL_A and KCNTL_B, respectively. From t3 to t4, the data in the nodes A1 and A2 and that in the nodes A2 and A3 are “01” and “10”, respectively. That is, three consecutive logic data in the nodes A1, A2, and A3 is “101” and two transitions occur. Accordingly, from t24 to t26 similarly to t22 to t24, the kicker power source circuit KPS supplies the current 8L×Ia to the node Nint.

From t5 to t6, the data in the nodes A0 and A1 and that in the nodes A3 and A0 are “11” and “01”, respectively. Accordingly, the EXOR01 is logically low and the EXOR30 is logically high. The nodes D0 and D2 hold logically high data and logically low data, respectively.

After t6, the output-side kicker clock KO0 is activated (t26), and the data held in the nodes D0 and D2 is output as the control signals KCNTL_A and KCNTL_B, respectively. Accordingly, the control signal KCNTL_A is activated to be logically high and the control signal KCNTL_B is deactivated to be logically low. As a result, from t26 to t28, the kicker control circuit KCC activates only the switch control signal SW2_CNT to be logically low. Accordingly, the kicker power source circuit KPS supplies the current 4L×Ia to the node Nint. In this way, if only one data transition such as “011” occurs among the three consecutive logic data in the nodes A3, A0, and A1, the kicker power source circuit KPS supplies a relatively low current to the node Nint.

From t7 to t8, the input-side kicker clock KI1 is activated, whereby the outputs from the gates G31 and G33 are held in the nodes D1 and D3, respectively. After t8, the output-side kicker clock KO1 is activated (t28), and the data held in the nodes D1 and D3 is output as the control signals KCNTL_A and KCNTL_B, respectively. From t7 to t8, the data in the nodes A1 and A2 and that in the nodes A2 and A3 are “10” and “00”, respectively. That is, three consecutive logic data in the nodes A1, A2, and A3 is “100” and only one transition occurs. Accordingly, from t28 to t30 similarly to t26 to t28, the kicker power source circuit KPS supplies the current 4L×Ia to the node Nint.

Although not shown, if there is no transition among three arbitrary consecutive data out of the data in the nodes A0, A1, A2, A3, A0, A1, A2, A3 . . . (the output signal PFout), then the kicker control circuit KCC deactivates both the control signals KCTNL_A and KCTNL_B to be logically low, deactivates the switch control signals SW2_CNT and SW3_CNT, and turns off the kicker power source circuit KPS.

According to the second embodiment, the kicker control circuit KCC can detect all the transitions among the consecutive digital data PFout, and can change the current supplied by the kicker power source circuit KPS. For example, if the output data PFout is “00110011 . . . 01010101 . . . ”, the number of data transitions is initially one at intervals of three consecutive data and then two at intervals of three consecutive data. Therefore, the kicker power source circuit KPS initially supplies the current 4L×Ia and then supplies the current 8L×Ia.

A feedback power source circuit FPS and the kicker power source circuit KPS according to the second embodiment can thereby maintain an internal power source voltage Vint more stably.

### Third Embodiment

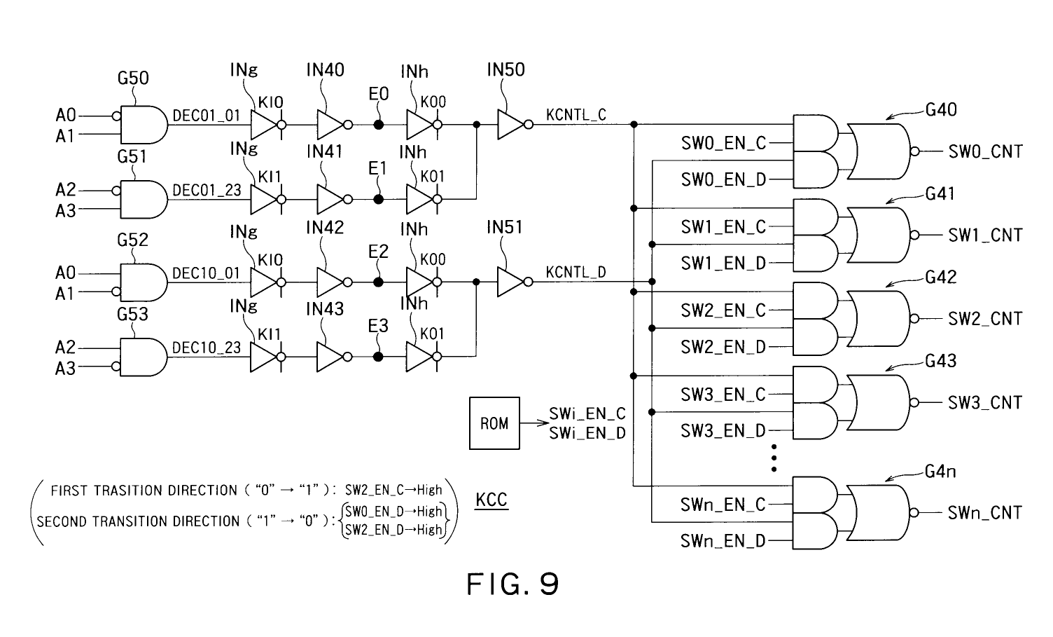

FIG. 9 is a circuit diagram showing a configuration of the kicker control circuit KCC included in a semiconductor device according to a third embodiment of the present invention. In the third embodiment, the kicker control circuit KCC is configured to detect a transition direction of digital data output consecutively from the core circuit CC, and to change a current supplied by the kicker power source circuit KPS according to the transition direction. The transition direction of digital data is a first transition direction of transition from “0” to “1” or a second transition direction of transition from “1” to “0”. The semiconductor device according to the third embodiment can be configured similarly to that according to the first embodiment except for the kicker control circuit KCC.

The kicker control circuit KCC according to the third embodiment includes AND gates G50 to G53, clocked inverters INg and INh, inverters IN40 to IN43, IN50, and IN51, and gate circuits G40 to G4n.

The gate G50 receives an inverted signal with respect to data in a node A0 and data in a node A1, and outputs an AND between them. The gate G51 receives an inverted signal with respect to data in a node A2 and data in a node A3, and outputs an AND between them. The gate G52 receives data in the node A0 and an inverted signal with respect to data in the node A1 and, and outputs an AND between them. The gate G53 receives the data in the node A2 and an inverted signal with respect to the data in the node A3 and, and outputs an AND between them.

If a data transition from A0 to A1 is in the first transition direction (from “0” to “1”), a signal DEC01_01 is activated to be logically high. The signal DEC01_01 is stored in a node E0. If a data transition from A2 to A3 is in the first transition direction, a signal DEC01_23 is activated to be logically high. The signal DEC01_23 is stored in a node E1. If the data transition from A0 to A1 is in the second transition direction (from “1” to “0”), a signal DEC10_01 is activated to be logically high. The signal DEC10_01 is stored in a node E2. If the data transition from A2 to A3 is in the second transition direction, a signal DEC10_23 is activated to be logically high. The signal DEC10_23 is stored in a node E3.

The data in the nodes E0 and E1 is transferred to the gate circuits G40 to G4n as control signals KCNTL_C at different timings. The data in the nodes E2 and E3 is transferred to the gate circuits G40 to G4n as control signals KCNTL_D at different timings. That is, the control signal KCNTL_C is a control signal indicating a data transition in the first transition direction and the control signal KCNTL_D is a control signal indicating a data transition in the second transition direction.

The gates G40 to G4n receive the kicker control signals KCNTL_C, and output switch control signals SW0_CNT to SWn_CNT according to switch enable signals SW0_EN_C to SWn_EN_C. The gates G40 to G4n receive the kicker control signals KCNTL_D, and output switch control signals SW0_CNT to SWn_CNT according to switch enable signals SW0_EN_D to SWn_EN_D, respectively.

It is assumed that current consumption of the off chip driver OCD when the transition of output data PFout is in the second transition direction (from “1” to “0”) is higher than that when the transition of output data PFout is in the first transition direction (from “0” to “1”). Therefore, it is preferable that a current Ib_10 supplied by the kicker power source circuit KPS when the control signal KCNTL_D is activated is higher than a current Ib_01 supplied by the kicker power source circuit KPS when the control signal KCNTLC is activated. In the third embodiment, the switch enable signals SW0_EN_C to SWn_EN_C and SW0_EN_D to SWn_EN_D are set so that the current Ib_10 is higher than the current Ib_01.

For example, only the signal SW2_EN_C among the switch enable signals SW0_EN_C to SWn_EN_C is set to be logically high. In this case, if a data transition occurs in the first transition direction, only the switch control signal SW2_CNT is activated to be logically low. As a result, the kicker power source circuit KPS supplies a current 4L×Ia to a node Nint as the current Ib_01.

The signals SW0_EN_D and SW0_EN_D among the switch enable signals SW0_EN_D to SWn_EN_D are set to be logically high. In this case, if data transition occurs in the second transition direction, the switch control signals SW0_CNT and SW2_CNT are activated to be logically low. As a result, the kicker power source circuit KPS supplies a current 5L×Ia to the node Nint as the current Ib_10.

In this example, the current Ib_10 is 25% higher than the current Ib_01. However, the magnitude relation of the currents Ib_10 and Ib_01 is not limited to this example. The current Ib_10 can be set to an arbitrary current higher than the current Ib_01 according to current consumption of the off chip driver OCD.

The configuration of the kicker control circuit KCC shown in FIG. 9 is given only as an example and the kicker control circuit KCC according to the third embodiment can use other logical circuits that perform operations in the same way as the circuits shown in FIG. 9 do. Furthermore, it is assumed in the third embodiment that the current consumption of the off chip driver OCD when data transition from “1” to “0” occurs is higher than that when data transition from “0” to “1” occurs. However, the relation between the transition direction of the data and the current consumption can be opposite. In this case, the current Ib_01 is set higher than the current Ib_10.

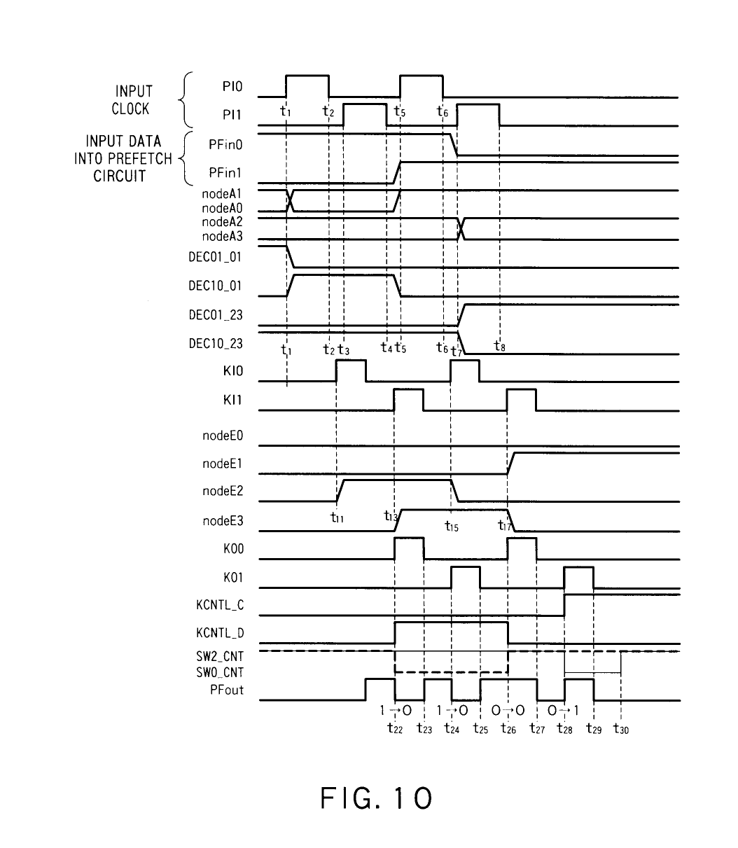

FIG. 10 is a timing diagram showing an operation performed by the semiconductor device according to the third embodiment. Operations related to data on fetch clocks PI0 and PI1, data input to input portions PFin0 and PFin1, and data held in the nodes A0 to A3 are identical to those shown in FIG. 6. FIG. 10 does not show the operations related to the data input to the input portions PFin0 and PFin1.

Signals DEC01_01 to DEC10_23 are determined according to logical states of the data in the nodes A0 to A3.

From t1 to t2, the data in the nodes A0 and A1 is “1” and “0”, respectively (the second transition direction). Accordingly, the signal DEC10_01 output from the gate G52 is activated to be logically high. The output signal DEC01_01 is inactive.

Right after t2, a kicker clock KI0 is activated, thereby transferring the signals DEC01_01 and DEC10_01 to the nodes E0 and E2, respectively. The data in the nodes E0 and E2 are thereby set logically low and logically high, respectively.

From t3 to t4, the data in the nodes A2 and A3 are “1” and “0”, respectively (the second transition direction). Accordingly, the signal DEC10_23 output from the gate G53 is activated to be logically high. The output signal DEC01_23 is inactive.

Right after t4, at t13, a kicker clock KI1 is activated, thereby transferring the signals DEC01_23 and DEC10_23 to the nodes E1 and E3, respectively. The data in the nodes E1 and E3 are thereby set logically low and logically high, respectively.

After t11, at t22, a kicker clock KO0 is activated. The data in the nodes E0 and E2 is thereby transmitted as the kicker control signals KCNTL_C and KCNTL_D, respectively. Accordingly, only the kicker control signal KCNTL_D is activated to be logically high. The kicker control signal KCNTL_C is inactive.

According to activation of the kicker control signal KCNTL_D, the gate circuits G40 to G4n output the switch control signals SW0_CNT to SWn_CNT according to the switch enable signals SW0_EN_D to SWn_EN_D. In the third embodiment, the gate circuit G40 to G4n activate the switch control signals SW0_CNT and SW0_CNT to be logically low to make switches SW0 and SW2 of the kicker power source circuit KPS conductive. As a result, the kicker power source circuit KPS supplies a current of 5L×Ia to the node Nint.

Similarly to the first embodiment, the third embodiment gives no considerations to the data transition from the node A1 to the node A2. Therefore, from t23 to t24, the kicker control circuit KCC and the kicker power source circuit KPS continue to perform the operations performed from t22 to t23.

After t13, at t24, a kicker clock KO1 is activated. The data in the nodes E1 and E3 is thereby transferred as the kicker control signals KCNTL_C and KCNTL_D, respectively. Since the transition occurs to the data in the nodes A2 and A3 in the second transition direction, operations performed by the kicker control circuit KCC and the kicker power source circuit KPS from t24 to t26 are same as those from t22 to t24.

From t5 to t6 when the fetch clock PI0 is activated, the data in the nodes A0 and A1 is “1” and “1”, respectively. Therefore, the output signals DEC01_01 and DEC10_01 (nodes E0 and E2) are both inactive.

After t15, at t26, the kicker clock KO0 is activated. The data in the nodes E0 and E2 is thereby transmitted as the kicker control signals KCNTL_C and KCNTL_D, respectively. Accordingly, the kicker control signals KCNTL_C and KCNTL_D are both inactive. In this case, the power source circuit KPS supplies no current to the node Nint. Similarly to the first embodiment, the third embodiment gives no consideration to the data transition from the node A3 to the node A0. Therefore, from t27 to t28, the kicker control circuit KCC and the kicker power source circuit KPS continue to perform the operations performed from t26 to t27.

From t7 to t8 when the fetch clock PI1 is activated, the data in the node A2 and that in the node A3 are “0” and “1”, respectively (in the first transition direction). Accordingly, the signal DEC01_23 (node E1) output from the gate G51 is activated to be logically high. The signal DEC10_23 (node E3) output from the gate G53 is inactive.

After t17, at t28, the kicker clock KO1 is activated, thereby transmitting the data in the nodes E1 and E3 as the kicker control signals KCNTL_C and KCNTL_D, respectively. Accordingly, only the kicker control signal KCNTL_C is activated to be logically high. The kicker control signal KCNTL_D is inactive.

According to activation of the kicker control signal KCNTL_C, the gate circuits G40 to G4n output the switch control signals SW0_CNT to SWn_CNT according to the switch enable signals SW0_EN_C to SWn_EN_C, respectively. In the third embodiment, the gate circuit G40 to G4n activate only the switch control signal SW2_CNT to be logically low to make only the switch SW2 of the kicker power source circuit KPS conductive. As a result, the kicker power source circuit KPS supplies a current of 4L×Ia to the node Nint.

Similarly to the first embodiment, the third embodiment gives no consideration to the data transition from the node A3 to the node A0. Therefore, from t29 to t30, the kicker control circuit KCC and the kicker power source circuit KPS continue to perform the operations performed from t28 to t29.

As described above, in the third embodiment, conductive states of the switches SW0 to SWn of the kicker power source circuit KPS are changed over according to the transition direction of the data PFout. The kicker control circuit KCC can thereby change the amount of the current supplied by the kicker power source circuit KPS. The third embodiment can also achieve effects of the first embodiment.

### Fourth Embodiment

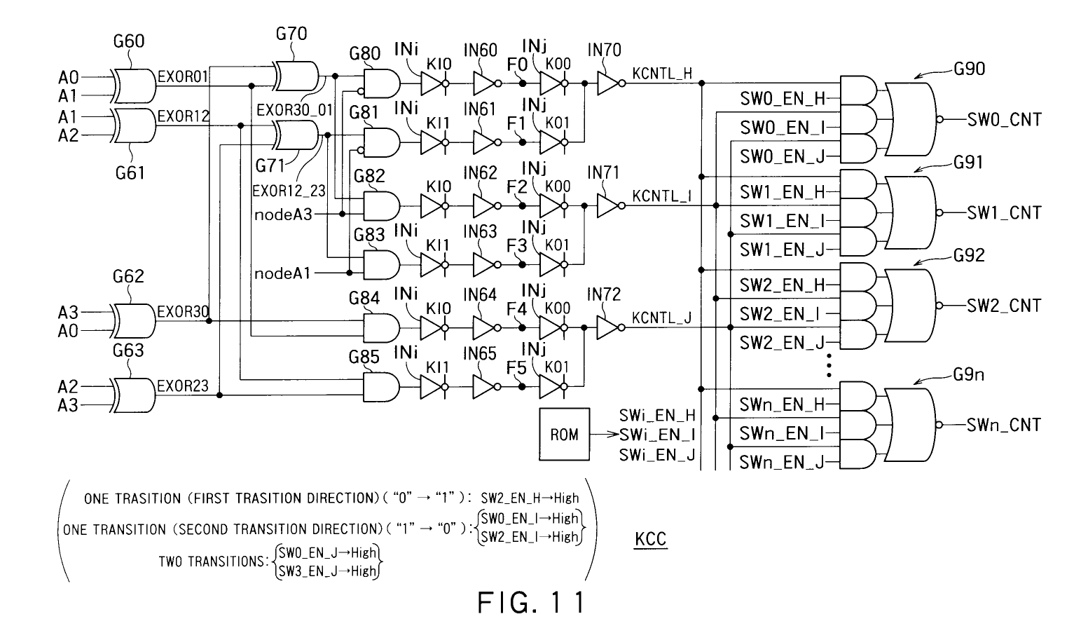

FIG. 11 is a circuit diagram showing a configuration of the kicker control circuit KCC included in a semiconductor device according to a fourth embodiment of the present invention. The fourth embodiment is similar to the second embodiment in that the kicker control circuit KCC controls the kicker power source circuit KPS to change an output current between an instance of one data transition and an instance of two data transitions for three consecutive data. Furthermore, the fourth embodiment is similar to the third embodiment in that the kicker control circuit KCC detects a transition direction of data if the number of data transitions is one for three consecutive data, and changes a current supplied by the kicker power source circuit KPS according to this transition direction. That is, the fourth embodiment is a combination of the second and third embodiments. Configurations of the semiconductor device according to the fourth embodiment can be same as those described in the first embodiment, except for the kicker control circuit KCC.

The kicker control circuit KCC according to the fourth embodiment includes EXOR gates G60 to G63, G70, and G71, AND gates G80 to G85, clocked inverters INi and INj, inverters IN60 to IN65 and IN70 to IN72, and gate circuits G90 to G9n.

The gate G60 receives data in a node A0 and that in a node A1 and outputs an exclusive-OR between them as a signal EXOR01. The gate G61 receives data in the node A1 and that in a node A2 and outputs an exclusive-OR between them as a signal EXOR12. The gate G62 receives data in a node A3 and that in the node A0 and outputs an exclusive-OR between them as a signal EXOR30. The gate G63 receives data in the node A2 and that in the node A3 and outputs an exclusive-OR between them as a signal EXOR23. The gate G70 receives the signals EXOR01 and EXOR30 and outputs an exclusive-OR between them as a signal EXOR30_01. The gate G71 receives the signals EXOR12 and EXOR23 and outputs an exclusive-OR between them as a signal EXOR12_23.

Further, the gate G80 receives the signal EXOR30_01 and inverted data with respect to the data in the node A3 and outputs an AND between them. Output data from the gate G80 is stored in a node F0 at a timing of activating an input kicker clock KI0. The gate G81 receives the signal EXOR12_23 and inverted data with respect to the data in the node A1 and outputs an AND between them. Output data from the gate G81 is stored in a node F1 at a timing of activating an input kicker clock KI1. The gate G82 receives the signal EXOR30_01 and the data in the node A3 and outputs an AND between them. Output data from the gate G82 is stored in a node F2 at a timing of activating the input kicker clock KI0. The gate G83 receives the signal EXOR12_23 and the data in the node A1 and outputs an AND between them. Output data from the gate G83 is stored in a node F3 at a timing of activating the input kicker clock KI1. The gate G84 receives the signals EXOR01 and EXOR30 and outputs an AND between them. Output data from the gate G84 is stored in a node F4 at a timing of activating the input kicker clock KI0. The gate G85 receives the signal EXOR12 and EXOR23 and outputs an AND between them. Output data from the gate G85 is stored in a node F5 at a timing of activating the input kicker clock KI1.

The data in the nodes F0, F2, and F4 is output as kicker control signals KCNTL_H, KCNTL_I, and KCNTL_J, respectively at a timing of activating an output kicker clock KO0. The data in the nodes F1, F3, and F5 is output as the kicker control signals KCNTL_H, KCNTL_I, and KCNTL_J, respectively at a timing of activating an output kicker clock KO1. The kicker control circuit KCC thereby outputs signals according to preset enable signals SW0_EN_H to SWn_EN_H, SW0_EN_I to SWn_EN_I or SW0_EN_J to SWn_EN_J, respectively.

The kicker control circuit KCC is described below in detail. If three consecutive data among that in the nodes A0 to A3 is all logically high or logically low, that is, no data transition occurs among three consecutive data, the nodes F0 to F5 are all logically low. Accordingly, the kicker control signals KCNTL_H, KCNTL_I, and KCNTL_J are all inactive, so that the kicker control circuit KCC does not drive the kicker power source circuit KPS.

If one data transition occurs to the three consecutive data among the data in the nodes A0 to A3, for example, if a data transition occurs between the nodes A3 and A0 or the nodes A0 and A1, the signal EXOR30_01 is activated to be logically high. In this way, if there is only one data transition among the consecutive data in the nodes A3, A0, and A1, the data in the node A1 is supposed to differ from that in the node A3.

If the data in the node A3 is logically low or “0”, the data in the node A1 is logically high or “1”. In this case, there is a transition from “0” to “1” among the consecutive data in the nodes A3, A0, and A1. Therefore, the logically high data is stored in the node F0. In this case, the kicker control signal KCNTL_H is activated at the timing of activating the kicker clock KO0. Accordingly, the kicker control circuit KCC outputs signals according to the enable signals SW0_EN_H to SWn_EN_H. For example, if only the enable signal SW2_EN_H is set logically high among the enable signals SW0_EN_H to SWn_EN_H, only the switch SW2 of the kicker power source circuit KPS is driven. In this manner, the kicker power source circuit KPS supplies the current of 4L×Ia to the node Nint.

If the data in the node A3 is “1”, the data in the node A1 is “0”. In this case, there is a transition from “1” to “0” among the consecutive data in the nodes A3, A0, and A1 (the second transition direction). Therefore, the logically high data is stored in the node F2. In this case, the kicker control signal KCNTL_I is activated at the timing of activating the kicker clock KO0. Accordingly, the kicker control circuit KCC outputs signals according to the enable signals SW0_EN_I to SWn_EN_I. For example, if only the enable signals SW0_EN_I and SW0_EN_I are set logically high among the enable signals SW0_EN_I to SWn_EN_I, the switches SW0 and SW2 of the kicker power source circuit KPS are driven. In this manner, the kicker power source circuit KPS supplies the current of 5L×Ia to the node Nint.

Similarly, for example, if a data transition occurs between the nodes A1 and A2 or the nodes A2 and A3, the signal EXOR12_23 is activated to be logically high. In this way, if there is only one data transition among the consecutive data in the nodes A1, A2, and A3, the data in the node A1 is supposed to differ from that in the node A3.

If the data in the node A1 is logically low or “0”, the data in the node A3 is logically high or “1”. In this case, there is a transition from “0” to “1” among the consecutive data in the nodes A1, A2, and A3 (the first transition direction). Therefore, the logically high data is stored in the node F1. In this case, the kicker control signal KCNTL_H is activated at the timing of activating the kicker clock KO1. Accordingly, the kicker control circuit KCC outputs signals according to the enable signals SW0_EN_H to SWn_EN_H. In this manner, the kicker power source circuit KPS supplies the current of 4L×Ia to the node Nint.

If the data in the node A1 is “1”, the data in the node A3 is “0”. In this case, there is a transition from “1” to “0” among the consecutive data in the nodes A1, A2, and A3 (the second transition direction). Therefore, the logically high data is stored in the node F3. In this case, the kicker control signal KCNTL_I is activated at the timing of activating the kicker clock KO1. Accordingly, the kicker control circuit KCC outputs signals according to the enable signals SW0_EN_I to SWn_EN_I. In this manner, the kicker power source circuit KPS supplies the current of 5L×Ia to the node Nint.

If two data transitions occur among three consecutive digital in the nodes A0 to A3, both of the signals EXOR01 and EXOR30 are activated to be logically high, or the signals EXOR12 and EXOR23 are activated to be logically high. Therefore, the logically high data is stored in the node F4 or F5. In this case, the kicker control signal KCNTL_J is activated at the timing of activating the kicker clock KO0 or a kicker clock KO1. Accordingly, the kicker control circuit KCC outputs signals according to the enable signals SW0_EN_J to SWn_EN_J. For example, if the enable signals SW0_EN_J and SW3_EN_J are set logically high among the enable signals SW0_EN_J to SWn_EN_J, the switches SW0 and SW3 of the kicker power source circuit KPS are driven. In this manner, the kicker power source circuit KPS supplies the current of 9L×Ia to the node Nint.

In this way, the kicker control circuit KCC according to the fourth embodiment can adjust the current output from the kicker power source circuit KPS while considering a transition frequency and the transition direction of the output signal PFout.

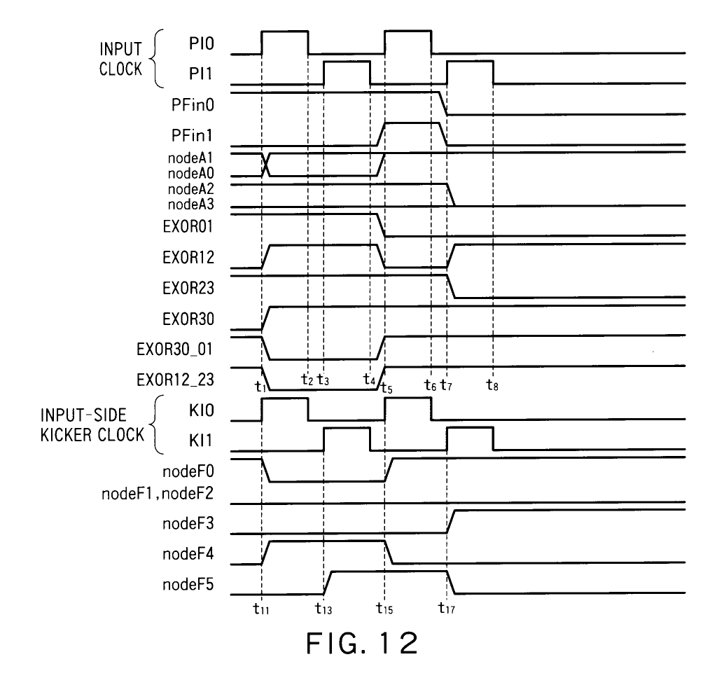

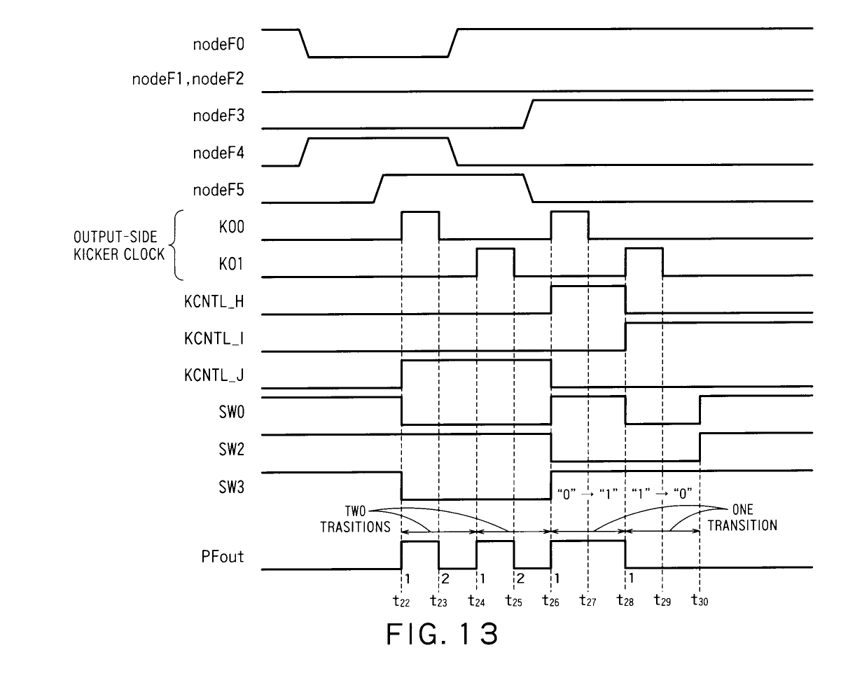

FIGS. 12 and 13 are timing diagrams showing an operation performed by a semiconductor device according to the fourth embodiment. Operations related to data on fetch clocks PI0 and PI1, data input to input portions PFin0 and PFin1, and data held in the nodes A0 to A3 are identical to those shown in FIG. 6.

In FIG. 12, from t1 to t4, the data in the nodes A0 to A3 is “1010”. The three consecutive data (A3, A0, and A1) include two transitions. Further, the three consecutive data (A1, A2, and A3) also include two transitions. Accordingly, when the input-side kicker clock KI0 is activated (t11), the node F4 is kept logically high. When the input-side kicker clock KI1 is activated (t13), the node F5 is kept logically high.

After t13, at t22 in FIG. 13, the output-side kicker clock KO0 is activated and the data in the nodes F0, F2, and F4 is output as the kicker control signals KCNTL_H, KCNTL_I, and KCNTL_J, respectively. From t22 to t23, only the node F4 is activated to be logically high, so that the kicker control signal KCNTL_J is activated to be logically high. As a result, from t22 to t23, the kicker control circuit KCC outputs signals according to the enable signals SW0_EN_J to SWn_EN_J. For example, if the enable signals SW0_EN_J and SW3_EN_J are set logically high as stated above, the kicker power source circuit KPS supplies the current of 9L×Ia to the node Nint.

At t23, the output-side kicker clock KO0 falls but the kicker control signal KCNTL_J is kept logically high. Therefore, from t23 to t24, the kicker control circuit KCC keeps outputs according to the enable signals SW0_EN_J to SWn_EN_J.

Thereafter, at t24, the output-side kicker clock KO1 is activated and the data in the nodes F1, F3, and F5 is output as the kicker control signals KCNTL_H, KCNTL_I, and KCNTL_J, respectively. From t24 to t25, only the node F5 is activated to be logically high. Accordingly, the kicker control signal KCNTL_J is kept logically high. As a result, from t24 to t25 similarly to a period from t23 to t24, the kicker control circuit KCC outputs signals according to the enable signals SW0_EN_J to SWn_EN_J.

At t25, the output-side kicker clock KO1 falls but the kicker control signal KCONTL_J is kept logically high. Accordingly, from t25 to t26, the kicker control circuit KCC keeps output according to the enable signals SW0_EN_J to SWn_EN_J.

Referring back to FIG. 12, from t5 to t6, the data in the nodes A0 to A3 is “1110”. The three consecutive data (A3, A0, and A1) includes one transition. The data transition direction in this case if from “0” to “1”. In addition, the three consecutive data (A1, A2, and A3) includes one transition. The data transition direction in this case is from “1” to “0”. Accordingly, when the input-side kicker clock KI0 is activated (t15), the node F0 is kept logically high. When the input-side kicker clock KI1 is activated (t17), the node F3 is kept logically high.

After t17, at t26 in FIG. 13, the output-side kicker clock KO0 is activated and the data in the nodes F0, F2, and F4 is output as the kicker control signals KCNTL_H, KCNTL_I, and KCNTL_J, respectively. From t26 to t27, only the node F0 is activated to be logically high, so that the kicker control signal KCNTL_H is kept logically high. As a result, from t26 to t27, the kicker control circuit KCC outputs signals according to the enable signals SW0_EN_H to SWn_EN_H. For example, if only the enable signal SW2_EN_H is set logically high as stated above, the kicker power source circuit KPS supplies the current of 4L×Ia to the node Nint.

At t27, the output-side kicker clock KO0 falls but the kicker control signal KCNTL_H is kept logically high. Accordingly, from t27 to t28, the kicker control circuit KCC keeps outputs according to the enable signals SW0_EN_H to SWn_EN_H.

Thereafter, at t28, the output-side kicker clock KO1 is activated and the data in the nodes F1, F3, and F5 is output as the kicker control signals KCNTL_H, KCNTL_I, and KCNTL_J, respectively. From t28 to t29, only the node F3 is activated to be logically high, so that the kicker control signal KCNTL_I is activated to be logically high. As a result, from t28 to t29, the kicker control circuit KCC outputs signals according to the enable signals SW0_EN_I to SWn_EN_I. For example, if the enable signals SW0_EN_I and SW0_EN_I are set logically high as stated above, the kicker power source circuit KPS supplies the current of 5L×Ia to the node Nint.

At t29, the output-side kicker clock KO1 falls but the kicker control signal KCNTL_I is kept logically high. Accordingly, from t28 to t29, the kicker control circuit KCC keeps outputs according to the enable signals SW0_EN_I to SWn_EN_I.

As described above, the kicker control circuit KCC according to the fourth embodiment can change an amount of current supplied by the kicker power source circuit KPS based on the transition frequency and the transition direction of the output signal PFout. Further, the fourth embodiment can also achieve effects of the first embodiment.

### Fifth Embodiment

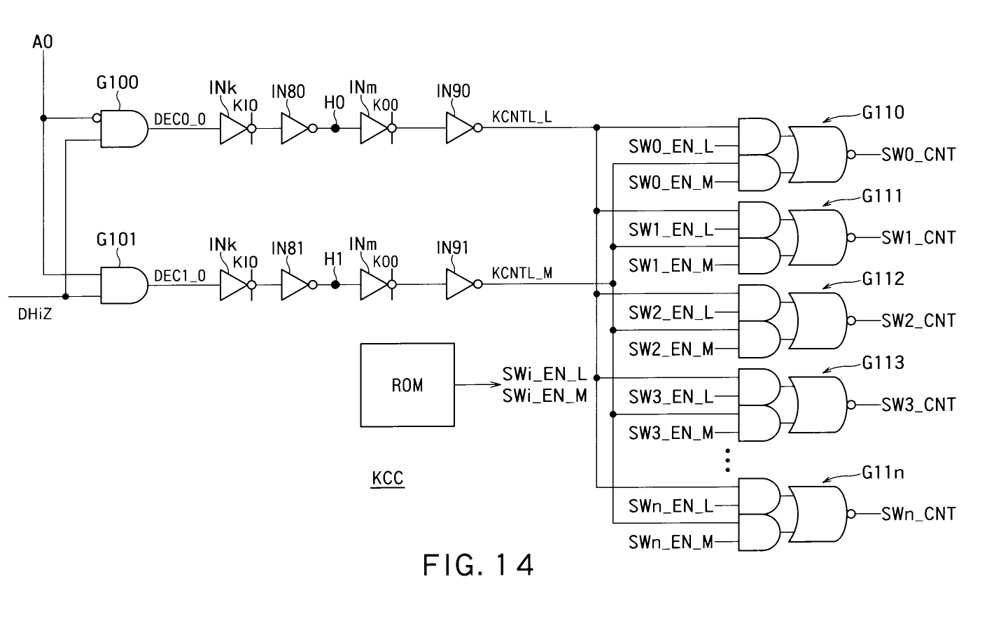

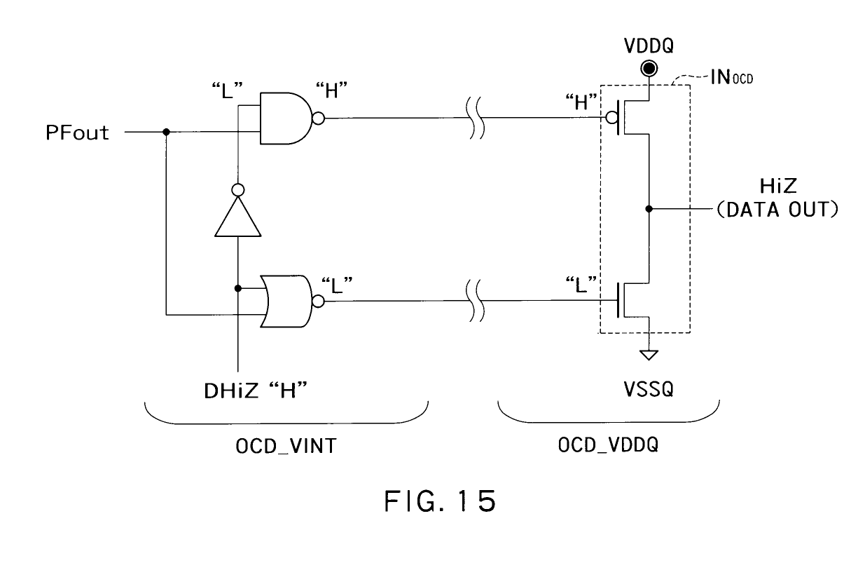

FIG. 14 is a circuit diagram showing a configuration of the kicker control circuit KCC included in a semiconductor device according to a fifth embodiment of the present invention. FIG. 15 shows how the off chip driver OCD operates in an output high impedance state. The kicker control circuit KCC according to the fifth embodiment changes an output current from the kicker power source circuit KPS according to data initially held in a node A0 right after end of an output impedance state. That is, after an output operation starts, the kicker control circuit KCC changes an amount of current to be supplied between an instance in which the data initially held in the node A0 is “0” and an instance in which the data is “1”.

The output high impedance state of the off chip driver OCD is described below.

Normally, if no data is output from I/O pads, an output from the off chip driver, that is, the I/O pads are in a high impedance state and disconnected from both a high-side power source VDDQ and a low-side power source VSSQ. Accordingly, the off chip driver OCD is in a state (an undefined state) in which the off chip driver OCD does not output either logically high data or logically low data.

As shown in FIG. 15, the off chip driver OCD generally includes an inverter INocd connected between the high-side power source VDDQ and the low-side power source VSSQ. The inverter INocd outputs the high-side power source VDDQ or the low-side power source VSSQ based on logic of a signal PFout. When the off chip driver OCD outputs “1”, a PMOS of the inverter INocd is turned on and an NMOS thereof is turned off. The off chip driver OCD thereby outputs logically high data (the power source VDDQ). When the off chip driver OCD outputs “0”, the NMOS of the inverter INocd is turned on and the PMOS thereof is turned off. The off chip driver OCD thereby outputs logically low data (VSSQ).

On the other hand, a high impedance signal DHiZ is a signal invalidating the output signal PFout and disconnecting both the high-side power source VDDQ and the low-side power source VSSQ from an output from the off chip driver OCD. Therefore, as shown in FIG. 15, when the output high impedance signal DHiZ is activated to be logically high, both the NMOS and PMOS of the inverter INocd are turned off. In this way, in the output high impedance state, the off chip driver OCD does not output either “0” or “1” and each node in the off chip driver OCD is in an intermediate state between a state of outputting “0” and that of outputting “1”. Accordingly, current consumption accompanying a state transition of each node in the off chip driver OCD right after a data output operation starts from the output high impedance state is lower than a current consumed by the off chip driver OCD during data transition (from “1” to “0” or from “0” to “1”) in a normal output operation. Furthermore, similarly to the third embodiment, if the current consumption of the off chip driver OCD differs depending on a data transition direction, the kicker control circuit KCC needs to change an amount of current supplied by the kicker power source circuit KPS according to logic of the signal PFout right after the data output operation starts.

Therefore, the kicker control circuit KCC according to the fifth embodiment changes the current output from the kicker power source circuit KPS according to the data initially held in the node A0 right after the high impedance state ends.

This kicker control circuit KCC operates according to the data initially held in the node A0 and then stops operating. After the off chip driver OCD leaves the high impedance state, the kicker control circuit KCC can operate similarly to one of the operations described in the first to fourth embodiments. That is, the kicker control circuit KCC according to the fifth embodiment controls the operation performed by the kicker power source circuit KPS right after the data output operation starts independently of subsequent operations.

The high impedance signal DHiZ is still activated to be logically high when the input-side kicker clock KI0 initially rises. That is, when a prefetch circuit PFC starts operating and fetches first output data, the off chip driver OCD is still in the high impedance state. At this stage, the kicker control circuit KCC determines the current supplied by the kicker power source circuit KPS according to the data in the node A0. Therefore, when the off chip driver OCD leaves the high impedance state and enters the output operation, the kicker power source circuit KPS can supply a current without delay.

The kicker control circuit KCC shown in FIG. 14 includes AND gates G100 and G101, clocked inverters INk and INm, inverters IN80, IN81, IN90, and IN91, and gate circuits G110 to G11n. The high impedance signal DHiZ is activated to be logically high when the off chip driver OCD is in the high impedance state.

The gate G100 receives inverted data with respect to the data in the node A0 and the signal DHiZ and outputs an AND between them. The gate G101 receives the data in the node A0 and the signal DHiZ and outputs an AND between them. The signal DHiZ is still activated to be logically high when the gate G100 receives the data initially held in the node A0. Therefore, if the initial data in the node A0 is “0”, a signal DEC0_0 is activated to be logically high. The signal DEC0_0 is held in a node H0 when an input-side kicker clock KI0 is activated. On the other hand, if transition from the initial data in the node A0 to “1” occurs, a signal DEC1_0 is activated to be logically high. The signal DEC1_0 is held in a node H1 when an input-side kicker clock KI0 is activated.

The data in the nodes H0 and H1 is output as kicker control signals KCNTL_L and KCNTL_M when activating an output-side kicker clock KO0, respectively. If the node H0 is logically high, the kicker control circuit KCC outputs switch control signals SW0_CNT to SWn_CNT according to switch enable signals SW0_EN_L to SWn_EN_L. If the node H1 is logically high, the kicker control circuit KCC outputs the switch control signals SW0_CNT to SWn_CNT according to switch enable signals SW0_EN_M to SWn_EN_M.

For example, it is assumed that only the switch enable signals SW0_EN_L and SW1_EN_L are activated to be logically high among the switch enable signals SW0_EN_L to SWn_EN_L. It is also assumed that only the switch enable signal SW1_EN_M is activated to be logically high among the switch enables signals SW0_EN_M to SWn_EN_M. if the initial data in the node A0 is “0” after a data output operation starts, the kicker power source circuit KPS supplies a current of 3L×Ia to a node Nint. On the other hand, if the initial data in the node A0 is “1”, the kicker power source circuit KPS supplies a current of 2L×Ia to the node Nint.

Data on the switch enable signals SW0_EN_L to SWn_EN_L and SW0_EN_M to SWn_EN_M can be stored in a ROM in advance. Alternatively, each of the switch enable signals SW0_EN_L to SWn_EN_L and SW0_EN_M to SWn_EN_M can be obtained by logical calculation between input data stored in the ROM and a certain operation control signal.

In this example, it is assumed that the kicker power source circuit KPS supplies a higher current if data transition from “1” to “0” occurs than that if data transition from “0” to “1” occurs to the node Nint so as to be adapted to the third embodiment. Further, in the third embodiment, the kicker power source circuit KPS outputs the current of 5L×Ia if the data transition from “1” to “0” occurs, and outputs the current of 3L×Ia if the data transition from “0” to “1” occurs.

Meanwhile, in the fifth embodiment, the kicker power source circuit KPS outputs the current of 3L×Ia if transition from the high impedance state to “0” occurs, and outputs the current of 2L×Ia if transition from the high impedance state to “1” occurs. In this way, the current output from the kicker power source circuit KPS when the initial data is output after the off chip driver OCD leaves the high impedance state and enters the data output state is set lower than the current output from the kicker power source circuit KPS when the data transition occurs in a normal output operation.

By this setting, the kicker control circuit KCC and the kicker power source circuit KPS can supply the current by as much as current consumption of the off chip driver OCD in proper amount.

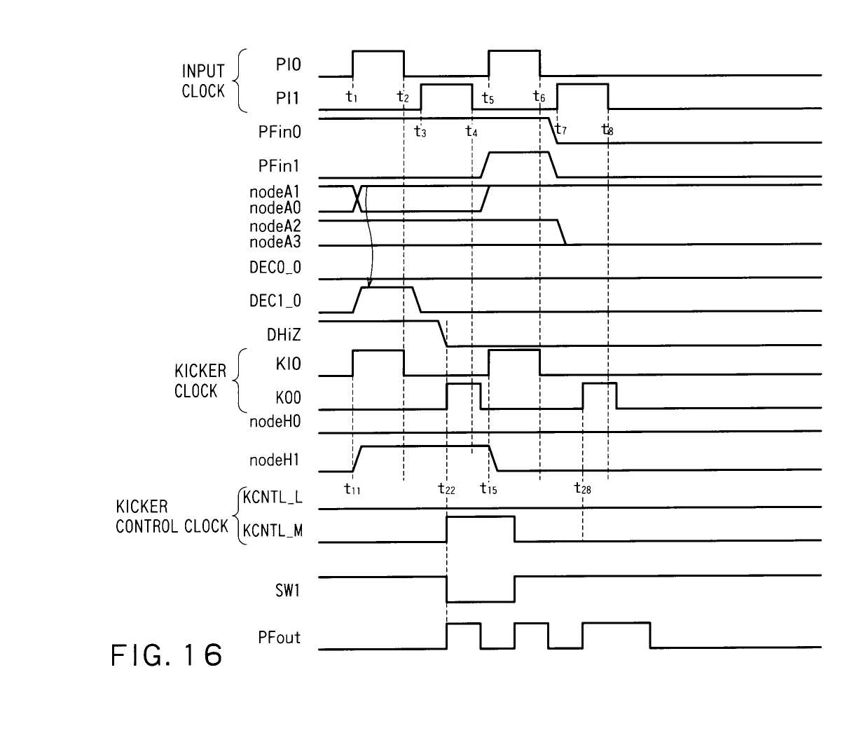

FIG. 16 is a timing diagram showing an operation performed by the semiconductor device according to the fifth embodiment. Operations related to data on fetch clocks PI0 and PI1, data input to input portions PFin0 and PFin1, and the data held in the nodes A0 to A3 are identical to those shown in FIG. 6.

The signals DEC0_0 to DEC1_0 are determined based on logic of the data in the nodes A0 to A3. In an example shown in FIG. 16, the data initially held in the node A0 after the off chip driver OCD leaves the high impedance state and enters the data output operation is “1”.

The output high impedance signal DHiZ is kept active until the output-side kicker clock KO0 is activated (t22) (just before output of the signal PFout). In the output high impedance state, the input-side kicker clock KI0 is activated (t11). The signals DEC0_0 and DEC1_0 are transmitted to the nodes H0 and H1, respectively. The data in the nodes H0 and H1 is thereby made logically low and logically high, respectively.

At t22, the high impedance state ends and the output-side kicker clock KO0 is activated. The data in the nodes H0 and H1 is thereby output to the gate circuits G110 to G11n as the kicker control clocks KCNTL_L and KCNTL_M, respectively. In the example of FIG. 16, the kicker control circuit KCC outputs the switch control signals SW0_CNT to SWn_CNT according to the enable signals SW0_EN_M to SWn_EN_M since the kicker control clock KCNTL_M is activated. In the fifth embodiment, the kicker control circuit KCC sets only the signal SW0_EN_M to be logically high among the switch enable signals SW0_EN_M to SWn_EN_M. Therefore, the kicker power source circuit KPS supplies the current of 2L×Ia to the node Nint at t22.

Although not shown in FIG. 16, if the initial data in the node A0 is “0”, the signal DEC0_0, the data in the node H0, and the kicker control clock KCNTL_L are activated to be logically high, and the switches SW0 and SW1 are turned on. Accordingly, the kicker power source circuit KPS supplies the current of 3L×Ia to the node Nint at t22.

As described above, the kicker control circuit KCC and the kicker power source circuit KPS according to the fifth embodiment can supply the current according to the initial output data to the node Nint when the off chip driver OCD leaves the high impedance state and enters the data output state. The kicker power source circuit KPS can thereby supply an appropriate current and suppress a variation in an internal power source voltage even if the current consumption of the off chip driver OCD is high at time of starting the data output operation.

The fifth embodiment can be applied to any of the first to fourth embodiments. In this case, it suffices that the kicker control circuit KCC according to any one of the first to fourth embodiments is combined with that according to the fifth embodiment. With this arrangement, the fifth embodiment can also achieve effects of any of the first to fourth embodiments.

### Sixth Embodiment

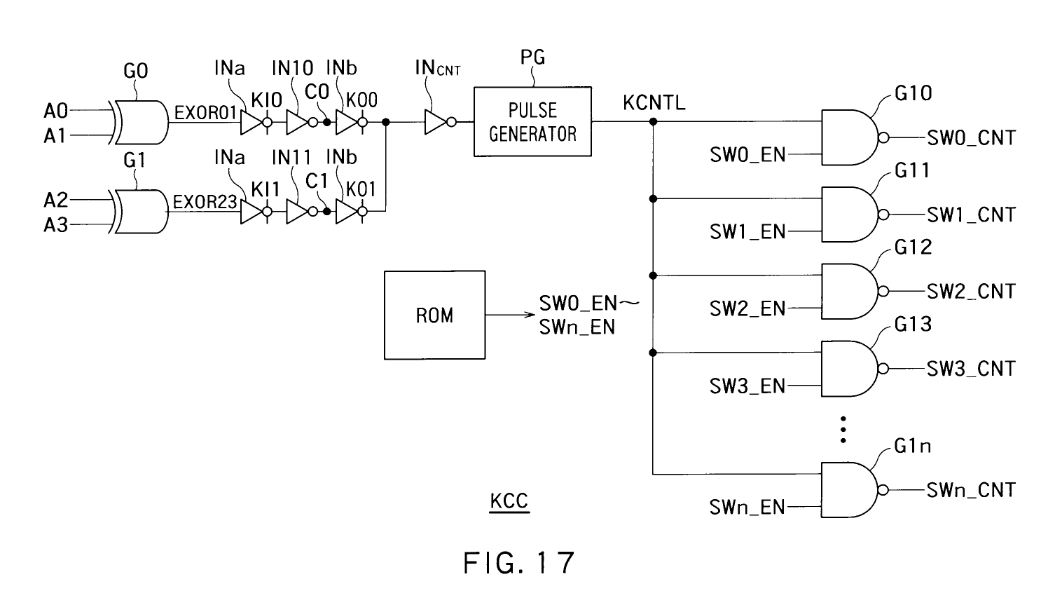

FIG. 17 is a circuit diagram showing a configuration of the kicker control circuit KCC included in a semiconductor device according to a sixth embodiment of the present invention. The kicker control circuit KCC according to the sixth embodiment further includes a pulse generator PG provided between an inverter INcnt and gates G10 to G1n. Configurations of the kicker control circuit KCC and other constituent elements according to the sixth embodiment can be same as those described in the first embodiment and shown in FIG. 4.

The present invention has been described so far on the premise that the kicker power source circuit KPS supplies “current” in condition that the operating frequency of the prefetch circuit PFC is constant. Generally speaking, a memory supports a plurality of operating frequencies and a width of each clock changes according to the operating frequency. Nevertheless, a quantity of charges consumed by the off chip driver OCD per transition of output data has no change.

Therefore, it is preferable that the kicker power source circuit KPS supplies constant charges irrespectively of the operating frequency. If charges supplied by the kicker power source circuit KPS are more than those consumed by the off chip driver OCD, the internal power source voltage VINT rises. If the former charges are fewer than the latter, the internal power source voltage VINT falls.

However, in the first embodiment, the output-side kicker clocks KO0 and KO1 control activation time of the kicker control signal as shown in FIG. 6. The operating frequency of the prefetch circuit PFC including the output-side kicker clocks KO0 and KO1 is determined by the fetch clocks PI0 and PI1. If the frequency of the output signal PFout changes, frequencies of the output-side kicker clocks KO0 and KO1 and the output signal PFout change. Accordingly, the quantity of charges supplied by the kicker power source circuit KPS changes depending on the operating frequency of the output-side kicker clocks KO0 and KO1, that is, depending on the activation time.

Under these circumstances, according to the sixth embodiment, the pulse generator PG is additionally provided in the kicker control circuit KCC. This enables the kicker power source circuit KPS to supply charges according to the number of transitions occurring to the output signal PFout to the node Nint without depending on the operating frequency of the output-side kicker clocks KO0 and KO1. In the configuration shown in FIG. 17, the pulse generator PG generates a pulse signal having a constant width irrespective of the operating frequency, and transmits the pulse signal to gates G10 to Gin as a kicker control signal KCNTL when an output from the inverter INcnt is activated (when the kicker control signal KCNTL is to be activated). That is, according to the sixth embodiment, the kicker control circuit KCNTL is a pulse signal having a constant width. The kicker control circuit KCC drives the kicker power source circuit KPS to supply a current only while the kicker control signal KCNTL is activated. Therefore, the kicker power source circuit KPS can supply charges in constant quantities irrespectively of the operating frequency.

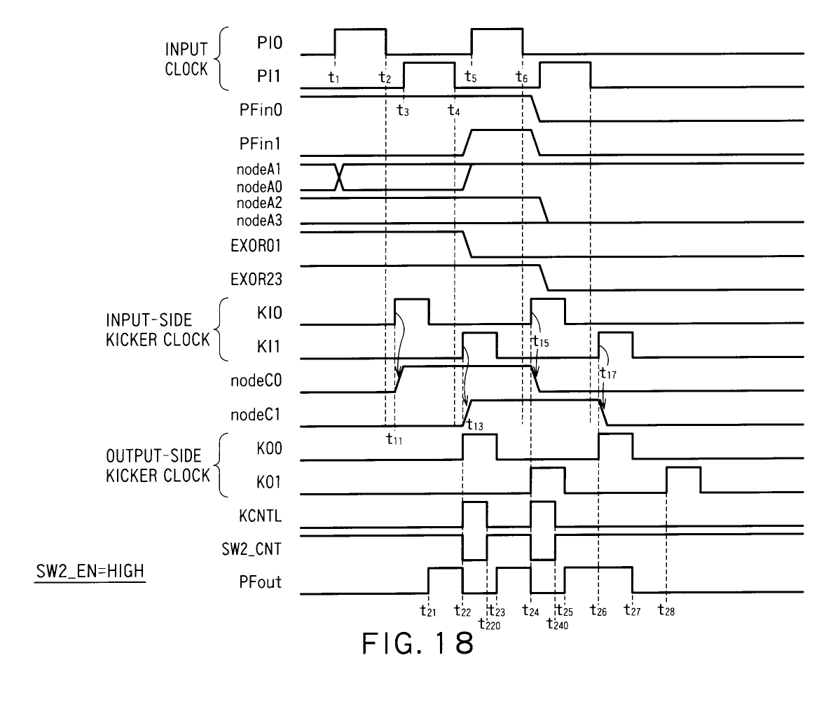

FIG. 18 is a timing diagram showing an output operation performed by the semiconductor device according to the sixth embodiment. At t22, data in a node C0 is transferred to the pulse generator PG to activate the kicker control signal KCNTL. Thereafter, the pulse generator PG continues to output charges for certain time to keep the kicker control signal KCNTL active until t220. At t24, data in a node C1 is transferred to the pulse generator PG to activate the kicker control signal KCNTL. The width of the pulse signal is determined according to the quantity of charges consumed by the off chip driver OCD due to one data transition.

In FIG. 18, the kicker control signal KCNTL and the switch control signals SWi_CNT are controlled to be pulsed. Other signal operations shown in FIG. 18 are same as those shown in FIG. 6

As described above, according to the sixth embodiment, the power source circuit KPS can supply the charges according to the number of data transitions occurring to the output signal PFout to the node Nint without depending on the operating frequency of the prefetch circuit PFC.

The sixth embodiment is applicable not only to the first embodiment but also to the second to fifth embodiments. In this case, the pulse generator PG is provided to correspond to one kicker control signal. Therefore, pulse generators PG are provided to correspond to kicker control signals KCNTL_A to KCNTL_M, respectively.

Further, the first to the fifth embodiments may include a single pulse generator, such as FIG. 17, and may be configured to control the output pulse widths of the signals from the pulse generator according to the kicker control signals KCNTL_A to KCNTL_M. In this case, the power source circuit KPS supplies a constant current value to the node Nint in a unit time. However, the power source circuit KPS can control the amount of charges to the node Nint by changing the supplying time (the output pulse widths) in response to the logic transitions.

Accordingly, the sixth embodiment can also achieve effects of any of the first to fifth embodiments.

### Seventh Embodiment

In the first to sixth embodiments, one kicker power source circuit KPS can be provided for a plurality of I/O pads.

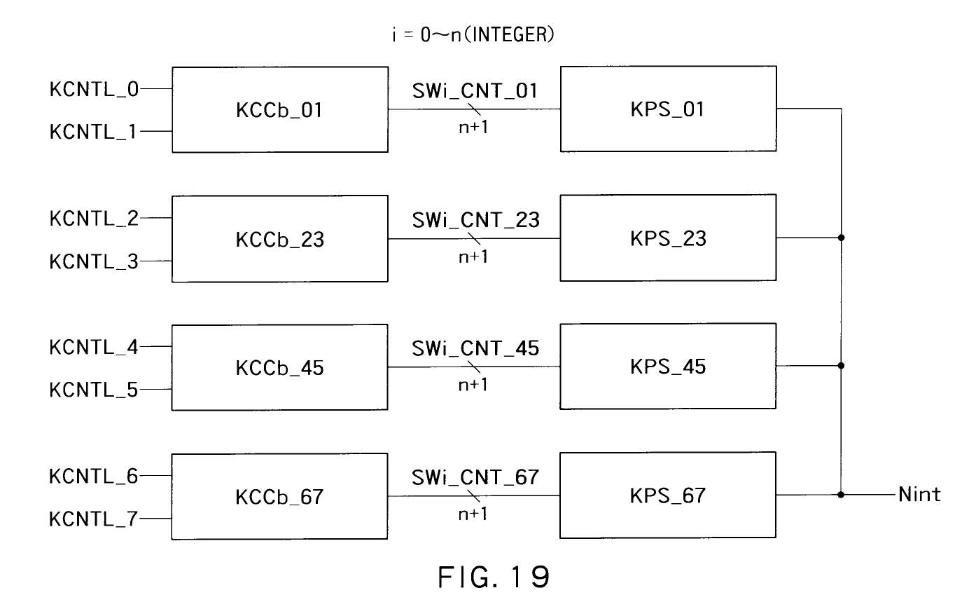

For example, FIG. 19 is a block diagram showing configurations of the kicker control circuit KCC and kicker power source circuits KPS according to a seventh embodiment of the present invention. In the seventh embodiment, four kicker power source circuits KPS are provided for eight I/O pads.

That is, one kicker power source circuit KPS is provided to correspond to two I/O pads. Each of kicker power source circuits KPS_01 to KPS_67 can be configured similarly to the kicker power source circuit KPS shown in FIG. 3.

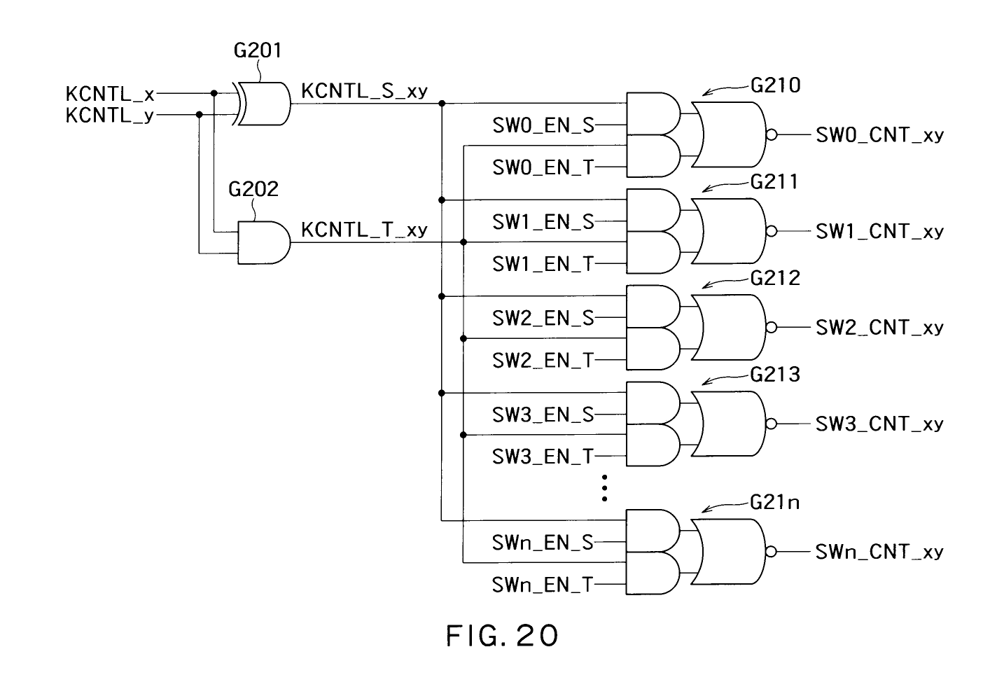

Each of rear portions KCCb_01 to KCCb_67 of the kicker control circuit KCC is configured to modify a rear portion KCCb of the kicker control circuit KCC shown in FIG. 4. FIG. 20 shows a configuration of each the rear portions KCCb_01 to KCCb_67 of the kicker control circuit KCC. Front portions of the kicker control circuit KCC can be configured similarly to a front portion KCCf of the kicker control circuit KCC shown in FIG. 4. Therefore, for example, eight front portions KCCf of the kicker control circuit KCC are provided to correspond to the I/O pads, respectively. On the other hand, each of the rear portions KCCb_01 to KCCb_67 of the kicker control circuit KCC is provided to correspond to two I/O pads (that is, two front portions KCCf). Since being similar in configuration to the front portion KCCf shown in FIG. 4, FIG. 19 does not show the front portions KCCf.

For example, the rear portion KCCb_01 of the kicker control circuit KCC receives kicker control signals KCNTL_0 and KCNTL_1 from the front portions corresponding to the two I/O pads IO0 and IO1 (not shown), respectively. The rear portion KCCb_01 logically calculates the kicker control signals KCNTL_0 and KCNTL_1, thereby controlling the kicker power source circuit KPS_01. If data transitions occur to both the I/O pads IO0 and IO1, the rear portion KCCb_01 controls the kicker power source circuit KPS_01 to supply a high current Imax to a node Nint. If a data transition occurs to one of the I/O pads IO0 and IO1, the rear portion KCCb_01 controls the kicker power source circuit KPS_01 to supply a current half as high as the current Imax to the node Nint. If data transitions do not occur to either the I/O pad IO0 or IO1, the rear portion KCCb_01 controls the kicker power source circuit KPS_01 to supply no current to the node Nint.

Similarly to the rear portion KCCb_01, each of the other rear portions KCCb_23 to KCCb_67 of the kicker control circuit KCC operates according to data transition of the two corresponding I/O pads (IO2, IO3), (IO4, IO5) or (IO6, IO7).

FIG. 20 is a circuit diagram showing a configuration of each of the rear portions KCCb_01 to KCCb_67 of the kicker control circuit KCC. A rear portion KCCb_xy (where xy=01, 23, 45 or 67) of the kicker control circuit KCC receives kicker control signals KCNTL_x and KCNTL_y from front portions KCCf_xy corresponding to I/O pads IOx and IOy, respectively.

The rear portion KCCb_xy of the kicker control circuit KCC includes an EXOR gate G201, an AND gate G202, and gate circuits G210 to G21n. The EXOR gate G201 outputs an exclusive-OR between the kicker control signals KCNTL_0 and KCNTL_1 as a kicker control signal KCNTL_S_xy. The EXOR gate G201 activates the kicker control signal KCNTL_S_xy to be logically high if a transition occurs to data output from one of the I/O pads IOx and IOy.

The AND gate G202 outputs an AND between the kicker control signals KCNTL_0 and KCNTL_1 as a kicker control signal KCNTL_T_xy. The AND gate G202 activates the kicker control signal KCNTL_T_xy to be logically high if transitions occur to data output from both the I/O pads IOx and IOy.

If the kicker control signal KCNTL_S_xy is activated, the gate circuits G210 to G21n output enable signals SWi_EN_S as switch control signals SWi_CNT_xy. For example, it is assumed that only the signal SW2_EN_2 is set logically high among the enable signals SWi_EN_S. In this assumption, only the switch control signal SW2_CNT_xy is activated and, similarly to the first embodiment, the corresponding kicker power source circuit KPS_xy supplies a current 4L×Ia to the node Nint.

On the other hand, if the kicker control signal KCNTL_T_xy is activated, the gate circuits G210 to G21n output enable signals SWi_EN_T as switch control signals SWi_CNT_xy. For example, it is assumed that only the signal SW3_EN_T is set logically high among the enable signals SWi_EN_T. In this assumption, only the switch control signal SW3_CNT_xy is activated and the corresponding power source circuit KPS_xy supplies a current 8L×Ia to the node Nint.

Furthermore, if no transition occurs to the data output from both the I/O pads IOx and IOy, neither the kicker control signals KCNTL_S_xy nor KCNTL_T_xy are activated and the kicker power source circuits KPS supply no current to the node Nint.

In this way, the kicker control circuit KCC (including the front portions KCC_f and the rear portions KCC_b_xy) can adjust an amount of current supplied to the node Nint according to transitions of the data output from a plurality of I/O pads, respectively. For example, the rear portions KCC_b_xy of the kicker control circuit KCC can control the corresponding kicker power source KPS_xy to supply an amount of current proportional to the number of I/O pads to which data transition occurs.

The seventh embodiment is also applicable to the second to sixth embodiments other than the first embodiment. If a plurality of kicker control signals KCNTL_A to KCNTL_M are generated for one I/O pad (corresponding to the second to fifth embodiments), the gates G201 and G202 are provided to correspond to each of the kicker control signals (KCNTL_A to KCNTL_M). The gates G201 and G202 corresponding to each of the kicker control signals (KCNTL_A to KCNTL_M) receive the kicker control signals KCNTL_x and KCNTL_y corresponding to a plurality of I/O pads, respectively. Accordingly, one rear portion of the kicker control circuit KCC receives Z signals, the number Z of which is obtained by multiplying the number of kicker control signals (KCNTL_A to KCNTL_M) according to the second to fifth embodiments by the number of corresponding I/O pads. For example, in case of the second embodiment, one rear portion of the kicker control circuit KCC receives the kicker control signals (KCNTL_A and KCNTL_B) corresponding to the I/O pads, respectively. In this way, if the seventh embodiment is applied to the second embodiment, one rear portion of the kicker control circuit KCC receives four kicker control signals in all.

Moreover, in the modification of applying the seventh embodiment to the second embodiment, the gate circuits G210 to G21n are the same as those according to the seventh embodiment in that each of the gate circuits G210 to G21n includes one NOR gate. However, differently from the seventh embodiment, each of the gate circuits G210 to G21n is configured to make the NOR gate correspond to Z AND gates. For example, if the seventh embodiment is applied to the second embodiment, outputs from four AND gates are input to the NOR gate of each of the gate circuits G210 to G21n, and the NOR gate outputs an NOR calculation result. That is, if the seventh embodiment is combined with the second embodiment, the kicker power source circuit KPS can supply currents of four different stages to the node Nint.

Similarly, if the seventh embodiment is combined with the fourth embodiment, the kicker power source circuit KPS can supply currents of six different stages to the node Nint.

Thus, if it is assumed that the number of kicker control signals corresponding to the I/O pads, respectively being a and that the number of I/O pads corresponding to each kicker control circuit, respectively being β, each kicker power source circuit KPS can supply a current of Z (where Z=α×β) different stages to the node Nint.

In addition, in this case, the seventh embodiment can also achieve effects of any of the first to sixth embodiments.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A semiconductor device comprising:
a core circuit constituted by an integrated circuit;
a peripheral circuit including a driver configured to be supplied with a voltage from an internal power source and a voltage from an external power source and to output digital data transferred from the core circuit, and a fetch portion temporarily holding the digital data from the core circuit and transferring the digital data to the driver;
a first power source portion supplying the voltage from the internal power source to the driver via a power source line;
a second power source portion including a plurality of current driving strings each including a current driving element and a switching element connected in series between the external power source and the power source line, the second power source portion being configured to supply a current to the power source line separately from the first power source portion by driving the current driving strings; and
a power source controller controlling the second power source portion in order to drive at least one of the current driving strings when a logic transition occurs among consecutive bits of the digital data.

2. The device of claim 1, wherein the power source controller drives at least one of the current driving strings when the logic transition occurs either among consecutive bits of the digital data held in the fetch portion or among consecutive bits of the digital data to be held in the fetch portion.

3. The device of claim 1, wherein the power source controller detects a transition among consecutive bits of the digital data which is fetched in the fetch portion at a same timing, and drives at least one of the current driving strings when the logic transition occurs among the consecutive bits.

4. The device of claim 2, wherein the power source controller detects a transition among consecutive bits of the digital data which is fetched in the fetch portion at a same timing, and drives at least one of the current driving strings when the logic transition occurs among the consecutive bits.

5. The device of claim 1, wherein
the second power source portion supplies a first current to the power source line when one logic transition occurs among three consecutive bits of the digital data, and
the second power source portion supplies a second current higher than the first current to the power source line when two logic transitions occur among three consecutive bits of the digital data.

6. The device of claim 2, wherein
the second power source portion supplies a first current to the power source line when one logic transition occurs among three consecutive bits of the digital data, and
the second power source portion supplies a second current higher than the first current to the power source line when two logic transitions occur among three consecutive bits of the digital data.

7. The device of claim 1, wherein
the second power source portion supplies a first current to the power source line when a logic transition from “0” to “1” occurs among the consecutive bits of the digital data, and
the second power source portion supplies a second current different from the first current to the power source line when a logic transition from “1” to “0” occurs among the consecutive bits of the digital data.

8. The device of claim 2, wherein
the second power source portion supplies a first current to the power source line when a logic transition from “0” to “1” occurs among the consecutive bits of the digital data, and
the second power source portion supplies a second current different from the first current to the power source line when a logic transition from “1” to “0” occurs among the consecutive bits of the digital data.

9. The device of claim 3, wherein
the second power source portion supplies a first current to the power source line when a logic transition from “0” to “1” occurs among the consecutive bits of the digital data, and
the second power source portion supplies a second current different from the first current to the power source line when a logic transition from “1” to “0” occurs among the consecutive bits of the digital data.

10. The device of claim 1, wherein
the second power source portion supplies a first current to the driver when one logic transition from “0” to “1” occurs among three consecutive bits of the digital data,
the second power source portion supplies a second current different from the first current to the power source line when one logic transition from “1” to “0” occurs among the three consecutive bits of the digital data, and
the second power source portion supplies a third current higher than the first current and the second current to the power source line when two logic transitions occur among three consecutive bits of the digital data.

11. The device of claim 1, wherein the second power source portion supplies a current, which depends on a logic of data initially held in the fetch portion, to the power source line when the driver is to start to output the digital data from a high impedance state, in which the driver is not outputting the digital data.

12. The device of claim 2, wherein the second power source portion supplies a current, which depends on a logic of data initially held in the fetch portion, to the power source line when the driver is to start to output the digital data from a high impedance state, in which the driver is not outputting the digital data.

13. The device of claim 3, wherein the second power source portion supplies a current, which depends on a logic of data initially held in the fetch portion, to the power source line when the driver is to start to output the digital data from a high impedance state, in which the driver is not outputting the digital data.

14. The device of claim 1, wherein the second power source portion changes number of times of driving the current driving strings and supplies a current to the power source line according to number of logic transitions among a plurality of consecutive bits of the digital data, the consecutive bits includes bits fetched in the fetch portion at different timings.

15. The device of claim 2, wherein the second power source portion changes number of times of driving the current driving strings and supplies a current to the power source line according to number of logic transitions among a plurality of consecutive bits of the digital data, the consecutive bits includes bits fetched in the fetch portion at different timings.

16. The device of claim 2, wherein the power source controller includes a pulse generator generating a pulse signal having a constant width in order to drive at least one of the current driving strings so as to supply a constant amount of charge to the power source line.

17. The device of claim 2, wherein the power source controller includes a pulse generator generating a pulse signal having the pulse widths controlled by the logic transitions in order to drive at least one of the current driving strings so as to supply a certain amount of charge to the power source line in response to the logic transitions.

18. The device of claim 2, wherein the second power source portions are respectively provided for a plurality of output pads outputting data.
